(19) United States
(12) Patent Application Publication
(10) Pub. No.: US 2025/0249929 A1
(43) Pub. Date: Aug. 7, 2025

(54) VEHICLE CONTROL DEVICE AND VEHICLE CONTROL METHOD

(71) Applicant: DENSO CORPORATION, Kariya-city (JP)

(72) Inventors: Takuya KUME, Kariya-city (JP); Kazuki IZUMI, Kariya-city (JP)

(21) Appl. No.: 19/186,390

(22) Filed: Apr. 22, 2025

Related U.S. Application Data
(63) Continuation of application No. PCT/JP2023/041274, filed on Nov. 16, 2023.

(30) Foreign Application Priority Data
Dec. 9, 2022 (JP) 2022-197269

(51) Int. Cl. B60W 60/00; B60W 30/165; B60W 50/14

(52) U.S. Cl. CPC B60W 60/001; B60W 30/165; B60W 50/14; B60W 2720/10; B60W 2720/24

(57) ABSTRACT

A technique for executing automated driving control to autonomously drive a vehicle. In the technique, information about a gate point is acquired based on an output signal from a surrounding monitoring sensor, a wireless signal received from an external device, or map data. The gate point is a location on a toll road where multiple gates are provided. Data regarding a post-gate road that the vehicle is scheduled to travel on after passing the gate point is acquired. A target gate is set as a gate closest to the post-gate road among the multiple gates provided at the gate point. Lateral movement of the vehicle in a direction toward the target gate is executed based on the vehicle entering a preparation section that exists before the target gate.

### CROSS REFERENCE TO RELATED APPLICATIONS

The present application is a continuation application of International Patent Application No. PCT/J P 2023/041274 filed on Nov. 16, 2023, which designated the U.S. and claims the benefit of priority from Japanese Patent Application No. 2022-197269 filed on Dec. 9, 2022. The disclosures of all the above applications are incorporated herein.

### TECHNICAL FIELD

The present disclosure relates to a vehicle control device and a vehicle control method for passing through a toll road gate in automated driving.

### BACKGROUND

A vehicle control device passes through toll road gates using automated driving.

### SUMMARY

According to a technique for executing automated driving control to autonomously drive a vehicle. In the technique, information about a gate point is acquired based on an output signal from a surrounding monitoring sensor, a wireless signal received from an external device, or map data. The gate point is a location on a toll road where multiple gates are provided. Data regarding a post-gate road that the vehicle is scheduled to travel on after passing the gate point is acquired. A target gate is set as a gate closest to the post-gate road among the multiple gates provided at the gate point. Lateral movement of the vehicle in a direction toward the target gate is executed based on the vehicle entering a preparation section that exists before the target gate.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a diagram illustrating a configuration of an automated driving system.

FIG. 2 is a functional block diagram illustrating an automated driving ECU.

FIG. 3 is a flowchart illustrating an operation of the automated driving ECU when passing through a gate.

FIG. 4 is a diagram for explaining an example of setting a target gate according to a road scheduled to be traveled after passing through the gate.

FIG. 5 is a flowchart of processing for determining whether a lane change is necessary before passing through the gate.

FIG. 6 is a flowchart illustrating an example of temporary control.

FIG. 7 is a diagram for explaining an operation of the automated driving ECU according to a distance from a gate point.

FIG. 8 is a diagram for explaining another example of the operation of the automated driving ECU according to a distance from a gate point.

FIG. 9 is a diagram for explaining another example of the operation of the automated driving ECU according to a distance from a gate point.

FIG. 10 is a diagram for explaining another example of the operation of the automated driving ECU according to a distance from a gate point.

FIG. 11 is a diagram for explaining another example of setting a target gate.

FIG. 12 is a flowchart for explaining an operation of a processor involved in the setting of the target gate.

FIG. 13 is a flowchart for explaining an operation of the processor involved in implementation of external notification control.

FIG. 14 is a flowchart for explaining an operation of the processor involved in stopping of preceding-vehicle following control.

FIG. 15 is a flowchart for explaining an example of setting a target speed when passing through a gate.

FIG. 16 is a flowchart for explaining an example of setting the target speed when passing through a gate.

FIG. 17 is a diagram for explaining an example of setting a target gate when the number of lanes decreases after passing through a gate.

### DETAILED DESCRIPTION

In a comparative example, a vehicle control device passes through toll road gates using automated driving. The vehicle control device is capable of changing the gate to be passed through depending on whether or not a card for toll payment is installed in the vehicle.

If there is a branch after passing through a gate, the vehicle may move laterally (left or right) towards a road corresponding to the destination. Since the destination may differ for each vehicle, the trajectories of the vehicles around the gate are likely to intersect, increasing the risk of contact. Naturally, the greater the amount of lateral movement after passing through the gate, the higher the risk of contact.

According to the present disclosure, a vehicle control device and a vehicle control method are capable of reducing a possibility of contact with another vehicle in a road section after passing through a gate.

A vehicle control device disclosed here is configured to execute automated driving control to autonomously drive a vehicle. The vehicle control device includes a control device configured to acquire information about a gate point based on an output signal from a surrounding monitoring sensor, a wireless signal received from an external device, or map data. The gate point is a location on a toll road where multiple gates are provided. The control device is configured to acquire data regarding a post-gate road that the vehicle is scheduled to travel on after passing the gate point. The control device is configured to set a target gate as a gate closest to the post-gate road among the multiple gates provided at the gate point. The control device is configured to execute lateral movement of the vehicle in a direction toward the target gate based on the vehicle entering a preparation section that exists before the target gate.

A vehicle control method disclosed herein is a method for executing automated driving control to autonomously drive a vehicle. In the method, information about a gate point is acquired based on an output signal from a surrounding monitoring sensor, a wireless signal received from an external device, or map data. The gate point is a location on a toll road where multiple gates are provided. Data regarding a post-gate road that the vehicle is scheduled to travel on after passing the gate point is acquired. A target gate is set as a gate closest to the post-gate road among the multiple gates provided at the gate point. Lateral movement of the vehicle in a direction toward the target gate is executed based on the vehicle entering a preparation section that exists before the target gate.

According to the above device/method, the position of the subject vehicle in the lateral direction can be brought closer to the post-gate road before passing through the gate, thereby reducing the amount of lateral movement of the subject vehicle after passing through the gate. As a result, the possibility of contact with other vehicles can be reduced.

### INTRODUCTION

Hereinafter, one embodiment of the present disclosure will be described with reference to the drawings. The present disclosure is not limited to the following embodiments, and various modifications can be made without departing from the scope of the gist described below. The various supplements and modifications described below can be implemented in appropriate combinations as long as no technical contradictions arise. For components having the same function, the same reference numerals are used, and their descriptions may be omitted. Additionally, when referring to only a part of the configuration, the explanation provided earlier can be applied to the other parts.

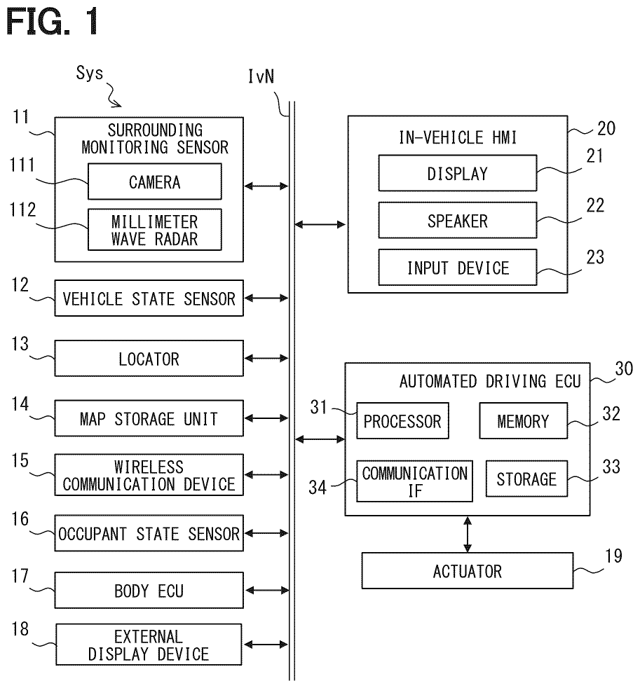

FIG. 1 is a diagram showing an example of a schematic configuration of an automated driving system Sys according to the present disclosure. Hereafter, a vehicle on which the automated driving system Sys is mounted is also described as a subject vehicle. In the present disclosure, the description “subject-vehicle lane” refers to a lane in which the subject vehicle is traveling among the multiple lanes provided on the road. The subject-vehicle lane can also be referred to as an ego lane. An adjacent lane refers to a lane that is next to the subject-vehicle lane.

In the present disclosure, a preceding vehicle refers to a vehicle that is traveling in the same lane as the subject vehicle and is the closest vehicle to the subject vehicle among vehicles present in front of the subject vehicle. A following vehicle refers to another vehicle that is traveling behind the subject vehicle in the same lane as the subject vehicle. A forward vehicle includes not only the vehicle traveling ahead of the subject vehicle in the same lane but also other vehicles traveling ahead of the subject vehicle in one or more adjacent lanes. Similarly, a rear vehicle includes not only the following vehicle but also vehicles traveling diagonally behind the subject vehicle.

In the present disclosure, the term “driver” refers to a person seated in a driver's seat, i.e., a driver seat occupant, regardless of whether he or she is actually driving. For example, in the present disclosure, the term “driver” may refer to a person who should receive the authority and responsibility for vehicle operation from the automated driving system Sys upon the termination of automated driving. The term “driver” in the present disclosure can be replaced with “driver seat occupant.” The subject vehicle may be a remotely operated vehicle controlled by an operator located outside the vehicle. The person who takes over the driving operation from the automated driving system Sys may be an operator located outside the vehicle. Here, the term “operator” refers to a person who has the authority to control the vehicle remotely from outside the vehicle. The operator is also included in the concept of the driver.

The automated driving system Sys provides a so-called automated driving function that allows the subject vehicle to travel autonomously along a predetermined route. The degree of automation of driving operations (hereinafter referred to as the automation level) can have multiple levels, as defined by the Society of Automotive Engineers (SAE International). The automation levels can be classified into six stages, for example, from Level 0 to Level 5.

Level 0 corresponds to fully manual driving, where the system does not perform any control. Level 1 is a level where the system supports either steering or acceleration/deceleration. Level 1 includes cases where only Adaptive Cruise Control (ACC) is executed. Level 2 refers to the level where the system performs both speed adjustment through accelerator and brake operations, and lateral control through steering wheel operations (i.e., steering). In Level 2, although driver monitoring of the surroundings (so-called “eyes-on”) is required, the system substantially allows the vehicle to drive autonomously. In this disclosure, Level 2 equivalent control is also referred to as automated driving control with surrounding monitoring obligations, Level 2 automated driving control, or semi-automated driving control.

Level 3 refers to the level where the system performs all driving tasks within the Operational Design Domain (ODD), while in emergencies, the control authority is transferred from the system to the driver. The ODD defines the conditions under which automated driving can be executed. Level 4 is the level at which the system performs all driving tasks, except in specific situations such as predetermined roads or extreme environments where it is not capable of operating. Level 5 is the level at which the system performs all driving tasks in all environments.

Automation levels 3 to 5 are the levels at which driver monitoring of the surroundings is not required, in other words, these levels correspond to automated driving. Therefore, in this disclosure, vehicle control corresponding to level 3 or higher is also referred to as automated driving control without the obligation of surrounding monitoring.

The following automated driving system Sys can be appropriately modified and implemented to conform to the regulations and customs of the region where it is used, as well as the characteristics and equipment of the installed vehicle. Unless otherwise specified, the term “system” hereinafter refers to the automated driving system Sys.

### Overall Configuration of the Automated Driving System Sys

The automated driving system Sys includes various configurations as shown in FIG. 1, as an example. That is, the automated driving system Sys includes a surrounding monitoring sensor 11, a vehicle state sensor 12, a locator 13, a map storage unit 14, a wireless communication device 15, an occupant state sensor 16, a body ECU 17, an external display device 18, and a driving actuator 19. In addition, the automated driving system Sys includes an in-vehicle HMI 20 and an automated driving ECU 30 (controller). It should be noted that ECU stands for Electronic Control Unit, which means an electronic control device. HMI stands for Human Machine Interface.

The automated driving ECU 30 is connected to each of the above-mentioned devices/sensors, such as the surrounding monitoring sensor 11, via an in-vehicle network IvN, enabling mutual communication. The in-vehicle network IvN is a communication network constructed within the vehicle. The standards for the in-vehicle network IvN can include various specifications such as Controller Area Network (hereinafter referred to as CAN: registered trademark) and Ethernet (registered trademark). Additionally, some of the devices/sensors may be directly connected to the automated driving ECU 30 via dedicated signal lines. The connection configurations between the devices can be modified as needed.

The surrounding monitoring sensor 11 is a sensor that detects objects present within its detection range. The surrounding monitoring sensor 11 can be understood as an autonomous sensor that senses the surrounding environment of the subject vehicle. The surrounding monitoring sensor can be referred to as an object detection sensor. The automated driving system Sys may be equipped with multiple surrounding monitoring sensors 11. The automated driving system Sys includes, for example, a camera 111 and a millimeter wave radar 112 as the surrounding monitoring sensors 11.

The camera 111 is a so-called front camera, which is arranged to capture images of the area in front of the vehicle at a predetermined angle of view. The camera 111 is positioned at a location such as the upper end of the interior side of the windshield, the front grille, or the rooftop. The camera 111 may include a camera ECU in addition to a camera body that generates image frames. The camera body includes at least an image sensor and a lens. The camera ECU includes a processor and memory. The processor is a CPU (Central Processing Unit) or a GPU (Graphics Processing Unit), for example. The camera ECU is an ECU that detects a predetermined target object by performing recognition processing on the image frames. The camera ECU detects and identifies objects registered as detection targets by using, for example, a classifier to which deep learning has been applied. In addition, the camera ECU calculates the relative position coordinates of the detected object with respect to the subject vehicle based on the position information (for example, pixel coordinates) of the detected object within the image frame.

The detection targets of the camera 111 include, for example, pedestrians and other moving objects such as other vehicles. The detection targets of the camera 111 also include static objects such as road edges, road markings, and structures installed along the roadside. Road markings include lane lines indicating lane divisions, pedestrian crossings, stop lines, guide lanes, safety zones, and regulatory arrows. Structures installed along the roadside include road signs, guardrails, curbs, utility poles, and traffic signals. The camera 111 can also detect the lighting status of illumination devices such as hazard lamps and turn signals (commonly known as blinkers) of the forward vehicle.

The automated driving system Sys may be equipped with multiple cameras 111. For example, the automated driving system Sys may be equipped with a side camera for capturing images of the sides of the vehicle and a rear camera for capturing images of the rear of the vehicle, in addition to the front camera, as the multiple cameras 111. The function of detecting target objects by analyzing camera images may be provided by other ECUs, such as the automated driving ECU 30. The functional arrangement within the automated driving system Sys can be modified as needed. The camera 111 outputs data related to detected objects to the in-vehicle network IvN. The data transmitted through the in-vehicle network IvN is referenced as needed by the automated driving ECU 30.

The millimeter wave radar 112 is a device that transmits probe waves, such as millimeter waves or quasi-millimeter waves, in a predetermined direction and analyzes the received data of the reflected waves that return after being reflected by objects, thereby detecting the relative position and relative speed of objects with respect to the subject vehicle. The automated driving system Sys may be equipped with multiple millimeter wave radars 112. The multiple millimeter wave radars 112 include a front millimeter wave radar and a rear millimeter wave radar. The front millimeter wave radar is a millimeter wave radar 112 that transmits probe waves towards the front of the vehicle and is installed, for example, in the front grille or the front bumper. The rear millimeter wave radar is a millimeter wave radar 112 that transmits probe waves towards the rear of the vehicle and is installed, for example, in the rear bumper. Each millimeter wave radar 112 generates data indicating the relative position and relative speed of detected objects and outputs this detection result to the automated driving ECU 30 or other relevant systems. The detection targets of the millimeter wave radar 112 may include other vehicles, pedestrians, manholes (iron plates), and three-dimensional structures used as landmarks, for example.

The surrounding monitoring sensors 11 may include not only the camera 111 and the millimeter wave radar 112 but also LiDAR, sonar, and other such sensors. LIDAR stands for Light Detection and Ranging, or Laser Imaging Detection and Ranging. LiDAR is a device that emits laser light to generate three-dimensional point cloud data indicating the positions of reflection points in each detection direction. LIDAR is also referred to as laser radar. The automated driving system Sys may also be equipped with multiple LiDARs and sonars. The combination of the surrounding monitoring sensors 11 provided in the automated driving system Sys can be changed as appropriate. The detection results from each surrounding monitoring sensor 11 are input into the automated driving ECU 30.

The vehicle state sensor 12 is a sensor that detects information related to the state of the subject vehicle. The vehicle state sensor 12 includes a speed sensor, a steering angle sensor, an acceleration sensor, a yaw rate sensor, and an accelerator pedal sensor. The speed sensor is a sensor that detects the driving speed of the subject vehicle. The steering angle sensor is a sensor that detects the steering angle. The acceleration sensor is a sensor that detects the acceleration acting in the longitudinal direction and the lateral acceleration acting in the lateral direction of the subject vehicle. The yaw rate sensor is a sensor that detects the angular velocity of the subject vehicle. The accelerator pedal sensor is a sensor that detects the depression amount/force of the accelerator pedal. The brake pedal sensor is a sensor that detects the depression amount/force of the brake pedal. The vehicle state sensor 12 outputs data indicating the current value (i.e., the detection result) of the physical state quantity to be detected to the in-vehicle network IvN. The types of sensors used by the automated driving system Sys as the vehicle state sensor 12 can be appropriately designed as needed.

The locator 13 is a device that calculates and outputs the position coordinates of the subject vehicle using navigation signals transmitted from positioning satellites that constitute the GNSS (Global Navigation Satellite System). The locator 13 includes a GNSS receiver and inertial sensors, for example. The locator 13 combines the navigation signals received by the GNSS receiver, measurement results from the inertial sensors, and vehicle speed information transmitted through the in-vehicle network IvN to sequentially calculate the subject vehicle's position and direction of travel. In this disclosure, the data indicating the position coordinates of the subject vehicle calculated by the locator 13 is referred to as subject-vehicle position data. The locator 13 outputs the subject-vehicle position data to the automated driving ECU 30.

The map storage unit 14 is a storage device that stores map data. The map data held by the map storage unit 14 may be so-called HD (High Definition) map data. The map data stored in the map storage unit 14 includes the three-dimensional shape of roads, the positions of road markings such as lane lines, and the positions of traffic signs, all with the accuracy required for automated driving and other applications. The map data includes gate point data. The gate point data is data about a gate point which is a location on a toll road where gates for toll collection are installed. The map data may include data for each gate point. The terms gate point/gate in this disclosure can be interpreted as toll booth.

The gate point data is data that indicates the structure and other characteristics of the gate point. At a single gate point, multiple gates can be installed side by side in the road width direction. The gate point data includes a representative location coordinate, the number of installed gates, the detailed position of each gate, and data related to the settlement method for each gate. The number of installed gates can be referred to as the number of lanes. Each gate provides a single lane (passage). The representative location coordinate is a coordinate that roughly indicate the position of the gate point. The representative location coordinate may be, for example, a coordinate of a gate (hereinafter referred to as a representative gate) located in the middle, at the right end, or at the left end among multiple gates arranged side by side. In this disclosure, a road section within a predetermined distance before and after the gate point represented by the representative location coordinate is referred to as a gate area. The gate area may be a section before and after the gate where lane markings are not provided (hereinafter referred to as a lane-free section). The gate area may be a section where the road width is expanded relative to the road connected to the gate area.

The detailed position data of each gate may be coordinate data such as latitude and longitude. The detailed position of each gate may be expressed by a number determined with the rightmost or leftmost gate being designated as number one. The data on the settlement method indicates the method of settling (paying) road tolls. The settlement method can be classified into manual settlement and automatic settlement methods. The manual settlement method involves the driver paying the toll by handing cash or a credit card to the gate staff, or by inserting it into a payment machine installed at the gate. The automatic settlement method involves a wireless communication device installed in the vehicle (commonly known as an on-board unit) communicating with wireless communication equipment installed at the gate (commonly known as a roadside unit) to process the payment according to the vehicle type and the section of the road traveled. In Japan, the manual settlement method may be referred to as “General,” while the automatic settlement method may be referred to as “ETC (registered trademark).” ETC stands for Electronic Toll Collection.

The map data stored in the map storage unit 14 may be updated with data received by the wireless communication device 15 from a map server or similar source. The map storage unit 14 may be a storage device that temporarily holds map data received by the wireless communication device 15 from a map server until the validity date of the data expires. The map data held by the map storage unit 14 may be navigation map data as long as it includes gate point data.

The wireless communication device 15 is a device for enabling the subject vehicle to conduct wireless communication with external devices. The external devices may include a server, a traffic information center, a roadside device, and some or all other vehicles. The wireless communication device 15 is configured to enable cellular communication. Cellular communication refers to wireless communication that complies with standards such as LTE (Long Term Evolution), 4G, or 5G. The wireless communication device 15 may also be configured to implement Cellular V2X (PC5/SideLink/Uu).

Additionally, the wireless communication device 15 is configured to enable short-range communication. In the present disclosure, short-range communication refers to wireless communication with a communication range limited to within a few hundred meters. The short-range communication methods used may include DSRC (Dedicated Short Range Communications) compliant with IEEE 802.11p, Wi-Fi (registered trademark), or Bluetooth (registered trademark) Low Energy. The short-range communication method may also be the aforementioned Cellular V2X. The wireless communication device 15 may be configured to perform data communication related to toll payment with a roadside unit installed at the gate when passing through the gate. For example, the wireless communication device 15 may be an on-board unit compatible with ETC 2.0.

The wireless communication device 15 may receive information about the gate point from an external device. For example, the wireless communication device 15 may receive information such as the location of gate points, passable gates, and blocked gates from a server or center. The wireless communication device 15 may receive vehicle information from surrounding vehicles through vehicle-to-vehicle communication. The vehicle information may include speed, current location, turn signal status, acceleration, movement trajectory, and other data. The surrounding vehicles mentioned here refer to vehicles that are within the range of vehicle-to-vehicle communication.

The occupant state sensor 16 is a sensor that detects the condition of the driver. The occupant state sensor 16 may be, for example, a Driver Status Monitor (hereinafter referred to as DSM). The DSM is a sensor that detects the driver's face orientation, gaze direction, eyelid openness, and other factors based on the driver's facial image. The DSM, as the occupant state sensor 16, is positioned on the instrument panel, the upper edge of the windshield, or similar locations such that it is oriented with its optical axis directed towards the driver's seat headrest, allowing it to capture images of the driver's face. The DSM, as the occupant state sensor 16, transmits driver status data indicating the driver's face orientation, gaze direction, eyelid openness, and other factors to the automated driving ECU 30. The occupant state sensor 16 may also be a pulse sensor, thermal camera, or similar device.

The body ECU 17 is an ECU that integrally controls the body-related in-vehicle devices installed in the vehicle. The body-related in-vehicle devices include lighting systems, horns, and door lock motors, for example. Lighting systems include headlights, hazard lamps, turn signals, backlights, and welcome lamps. The body-related in-vehicle devices may also include the external display device 18.

The external display device 18 is a projector that projects images onto the rear window. The external display device 18 can display images for communicating with drivers of other vehicles based on input signals from the automated driving ECU 30. For example, the external display device 18 displays images indicating the moving direction of the subject vehicle or images requesting the right of way (in other words, permission to merge) to the rear vehicle traveling in the adjacent lane. The external display device 18 is installed in a position where the projection light hits the rear window, such as on the ceiling of the vehicle interior (for example, near the upper end of the window frame).

The external display device 18 may also project onto the side windows or the road surface around the subject vehicle. The external display device 18 may be provided on the side mirrors to project images onto the road surface near the vehicle. The headlights or taillights may be configured to operate as the external display device 18. The external display device 18 may be a liquid crystal display or similar device arranged with the display surface facing the side or rear of the vehicle.

The in-vehicle HMI 20 is a group of interfaces for exchanging information between an occupant and the automated driving system Sys. The in-vehicle HMI 20 includes a display 21 and a speaker 22 as notification devices for conveying information to the driver. Additionally, the in-vehicle HMI 20 includes an input device 23 as an input interface for accepting operations from the occupant.

The automated driving system Sys includes, as the display 21, one or more of a head-up display (HUD), a meter display, and a center display. The HUD is a device that projects image light onto a predetermined area of the windshield, thereby displaying a virtual image that can be perceived by the driver. The meter display is a display positioned in the area directly in front of the driver's seat on the instrument panel. The center display is a display provided in the central part of the instrument panel in the vehicle's width direction. The meter display and center display can be implemented using a liquid crystal display or an organic light-emitting diode display. The display 21 shows images according to signals input from the automated driving ECU 30. The speaker 22 is a device that outputs sound corresponding to signals input from the automated driving ECU 30. The term “sound” in this disclosure includes notification sounds, voice, music, and the like.

The automated driving system Sys may also include other notification devices, such as a vibrator or ambient light. The ambient light is an illumination device realized by multiple LEDs (light emitting diodes), with adjustable emission colors and emission intensity. The ambient light is provided in the instrument panel, steering wheel, A-pillars, and the like. The A-pillar is the pillar located next to the windshield. The A-pillar can also be referred to as the front pillar.

The input device 23 is a device for receiving driver operation instructions for the automated driving system Sys. As the input device 23, a steering switch provided on the spoke part of the steering wheel, an operating lever provided on the steering column part, a touch panel overlaid on the center display, and the like can be adopted. The automated driving system Sys may include multiple types of devices as the input device 23.

The input device 23 outputs an operation signal, which is an electrical signal corresponding to the driver's operation, to the automated driving ECU 30. The operation signal includes information indicating the content of the driver's operation. The automated driving system Sys receives instructions related to changing the operation mode via the input device 23. The instructions related to changing the operation mode also include instructions for starting and ending automated driving. The automated driving system Sys may be configured to acquire various driver instructions through voice recognition. Devices related to voice input, such as a microphone, can also be included in the input device 23. Further, an HCU (HMI Control Unit) may be interposed between the in-vehicle HMI 20 and the automated driving ECU 30. The HCU is a device that comprehensively controls the notification of information to the driver.

The automated driving ECU 30 is an ECU that executes some or all of the driving operations in place of the driver by controlling the driving actuator 19 based on detection results from the surrounding monitoring sensors 11 and other inputs. The automated driving ECU 30 is also referred to as an automatic operation device. The driving actuator 19 includes, for example, a brake actuator, an electronic throttle, and a steering actuator. The steering actuator includes an EPS (Electric Power Steering) motor. Other ECUs, such as a steering ECU for steering control, a power unit control ECU for acceleration and deceleration control, and a brake ECU, may be interposed between the automated driving ECU 30 and the driving actuator 19.

The automated driving ECU 30 mainly includes a computer, which includes a processor 31, a memory 32, a storage 33, a communication interface 34, and a bus connecting these components. The memory 32 is a rewritable volatile storage medium. The memory 32 is, for example, RAM (Random Access Memory). The storage 33 is, for example, a rewritable non-volatile memory such as flash memory. The storage 33 stores a vehicle control program, which is executed by the processor 31. The vehicle control program includes a gate response program that creates a travel plan for passing through the gate. The execution of the vehicle control program by the processor 31 corresponds to the execution of a vehicle control method.

The automated driving ECU 30 is equipped with multiple operation modes with varying levels of automation. Each operation mode differs in the scope of driving tasks handled by the driver, in other words, the scope of driving tasks in which the system intervenes. The operation mode can be alternatively referred to as a driving mode. As an example, the automated driving ECU 30 is configured to switch between multiple operation modes, including at least a fully manual mode, a level 2 mode, and a level 3 mode.

The fully manual mode is an operation mode in which the driver performs all driving tasks. The fully manual mode corresponds to a mode in which the automated driving ECU 30 does not perform substantial vehicle control. The fully manual mode may also be a mode in which the operation of the automated driving ECU 30 is stopped (so-called stop mode). In the fully manual mode, the automated driving ECU 30 may continue to perform the recognition processing of the driving environment in the background (in other words, potentially) as a preparatory process for switching to the level 2 or level 3 mode.

The level 2 mode is an operation mode in which automated driving control with surrounding monitoring obligation is performed, in other words, vehicle control equivalent to the automation level 2. The level 2 mode can be referred to as a semi-automated driving mode or an eyes-on automated driving mode. The level 2 mode may be subdivided into a hands-on level 2 mode and a hands-off level 2 mode. In this embodiment, the hands-on level 2 mode of the automated driving ECU 30 is a mode that requires the driver to hold the steering wheel. The hands-off level 2 mode is an operation mode that does not require the driver to hold the steering wheel, in other words, it is an operation mode that allows hands-off driving. In this disclosure, hands-on refers to holding the steering wheel. Hands-off refers to the act of removing one's hands from the steering wheel. Eyes-on refers to monitoring the area outside the subject vehicle related to the direction of its movement (primarily the frontward direction). Eyes-off refers to the act of looking away from the area outside the subject vehicle related to the direction of its movement.

The level 3 mode is an operation mode that performs automated driving control without the obligation of monitoring the surroundings, equivalent to the automation level 3 vehicle control. The automated driving ECU 30 may be capable of implementing automated driving control equivalent to level 4 or higher. The level 3 mode can be referred to as automated driving mode or eyes-off automated driving mode. The automated driving ECU 30 may be equipped with multiple processors 31. The processor that executes level 3 or higher automated driving control may be provided separately from the processor that executes level 2 or lower vehicle control.

The automated driving ECU 30 automatically performs steering, acceleration, and deceleration (in other words, braking) of the subject vehicle so that the subject vehicle travels along the planned route towards the destination set by the driver while in automated driving mode. The automated driving ECU 30 may continue automated driving by selecting routes to keep traveling or circulating within the range that satisfies the ODD, even if a destination is not set.

The ODD may include conditions such as (a) the roadway being a highway or a dedicated road for automobiles equipped with a median strip and guardrails, (b) the rainfall amount being below a specified threshold, and (c) the presence of traffic congestion. Here, the dedicated road for automobiles refers to roads where the entry of pedestrians and bicycles is prohibited, including, for example, toll roads such as highways. Additionally, the traffic congestion refers to a condition where the travel speed is below a congestion determination value (for example, around 30 km/h) and other vehicles are present within a specified distance (for example, 20 meters) in front of and behind the subject vehicle. Furthermore, the ODD may also include conditions such as (d) all or a specified number of surrounding monitoring sensors 11 functioning correctly, and (e) the absence of parked vehicles on the road. The conditions for determining whether automated driving is possible or not, in other words, the detailed conditions defining the ODD, can be modified as necessary.

Additionally, the automated driving ECU 30 performs control for autonomous driving of the vehicle even while in the Level 2 mode. In other words, it performs the recognition of the driving environment, planning of the driving trajectory, and reflection/feedback into the control. Reflection into the control includes speed adjustments through acceleration and deceleration, as well as steering control. Unless otherwise noted, any mention of automated driving hereinafter can be replaced with Level 2 equivalent semi-automated driving.

In automated driving mode, the automated driving ECU 30 allows the driver to engage in secondary tasks. The secondary tasks permitted in Level 3 automated driving can be limited to activities such as reading or using a smartphone, which allow the driver to quickly resume control of the vehicle if necessary. The automated driving mode can be terminated due to driver steering/pedal operations (so-called override), system limitations, or exiting the ODD, among other reasons.

### Configuration of the Automated Driving ECU

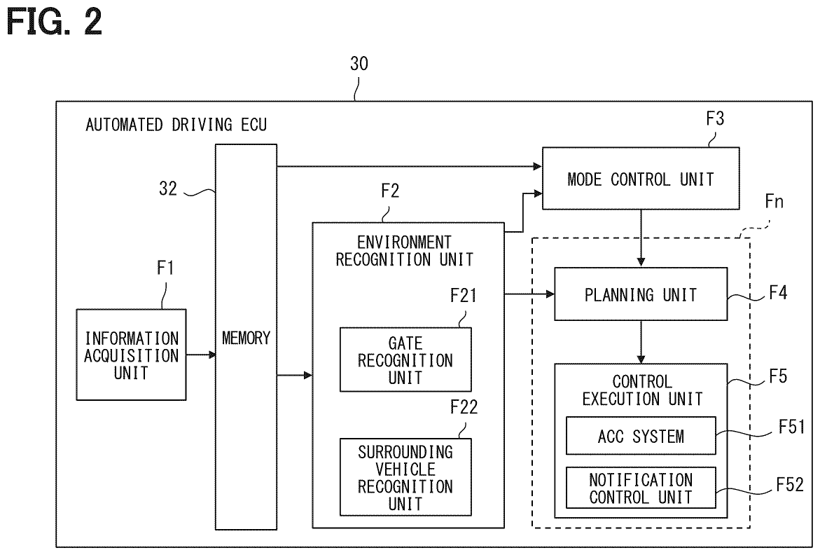

The automated driving ECU 30 includes functional units, as shown in FIG. 2, which are realized by executing the automated driving program. That is, the automated driving ECU 30 includes an information acquisition unit F1, an environment recognition unit F2, a mode control unit F3, a planning unit F4, and a control execution unit F5.

The information acquisition unit F1 acquires various types of information necessary for implementing vehicle control such as automated driving and driving assistance. The information acquisition unit F1 obtains sensing data (i.e., detection results) from the various surrounding monitoring sensors 11, including the camera 111. The sensing data includes information about objects present around the subject vehicle, such as moving objects, landmarks, and obstacles. The data for each detected object may include the position, movement speed, and its type or size.

The sensing data related to landmarks may include data on the detection results of lane lines and road edges. The data for lane lines may include not only position data but also line type data. The line type can be represented as either a solid line (continuous line) or a dashed line. The sensing data may also include data indicating the recognition status of lane lines, such as whether the lane lines are recognized, and the recognition status of road edges, such as whether the road edges are recognized.

Additionally, the information acquisition unit F1 obtains data indicating the vehicle's status from the vehicle state sensor 12, such as the subject vehicle's speed, acceleration, yaw rate, and external illumination. Furthermore, the information acquisition unit F1 acquires the subject-vehicle position data from the locator 13. The information acquisition unit F1 acquires the surrounding map information by referring to the map storage unit 14.

The information acquisition unit F1 acquires data transmitted from external devices using the wireless communication device 15. For example, the information acquisition unit F1 can acquire vehicle information transmitted from the forward vehicle via vehicle-to-vehicle communication. Additionally, the information acquisition unit F1 acquires dynamic map data for the road segments that the subject vehicle is scheduled to pass through within a predetermined time, in collaboration with the wireless communication device 15. The dynamic map data here includes traffic congestion information, merging vehicle information, and other relevant data.

The information acquisition unit F1 also acquires information on driver operations with respect to the automated driving system Sys based on signals from the input device 23. For example, the information acquisition unit F1 obtains instruction signals related to the start and end of automated driving from the input device 23. Additionally, the information acquisition unit F1 acquires data related to the operational status of the automated driving system Sys from various devices and software modules. For example, the information acquisition unit F1 also acquires data such as the operational status (on/off) of the ACC function and whether or not a preceding vehicle is recognized. Furthermore, the information acquisition unit F1 manages the operational status of various components, such as whether the surrounding monitoring sensors 11 are functioning properly. The information acquisition unit F1 acquires driver status data, such as the degree of eye openness and the direction of the line of sight, from the occupant state sensor 16.

The various data sequentially acquired by the information acquisition unit F1 are stored in a temporary storage medium, such as the memory 32, and are utilized by components such as the environment recognition unit F2 and the mode control unit F3. Additionally, the various types of information can be categorized and stored in the memory 32 according to their respective types. Furthermore, the various types of information can be sorted and stored such that, for example, the most recent data is at the beginning. Data that has exceeded a certain period of time since acquisition may be discarded. In the present disclosure, “acquisition” also includes the generation, detection, and determination performed by the automated driving ECU 30 based on calculations by the automated driving ECU 30 using data input from other devices or sensors. This is because the functional configuration within the system can be modified as necessary.

The environment recognition unit F2 recognizes a driving environment of the subject vehicle based on the subject-vehicle position data, the sensing data acquired by the information acquisition unit F1, and the map data. The environment recognition unit F2 may recognize the driving environment of the subject vehicle through sensor fusion processing, which integrates detection results from multiple surrounding monitoring sensors 11, such as the camera 111 and the millimeter wave radar 112, with predetermined weights.

The driving environment includes the curvature of the road, the number of lanes, the subject-vehicle lane number, the weather, the road surface conditions, the traffic volume, and the remaining distance to the gate point. The subject-vehicle lane number is a number indicating the position of the subject-vehicle lane on the road, determined with reference to the left edge of the road. The subject-vehicle lane number directly or indirectly indicates the number of lanes to the left of the subject-vehicle lane. Of course, the subject-vehicle lane number may also be expressed with reference to the right edge of the road. The subject-vehicle lane number may be identified using the distance from the edge of the road to the subject vehicle, the number of lane lines detected on the left and right, and some or all of the map data. The subject-vehicle lane number may be identified from the map data and the subject-vehicle position data. The identification of the subject-vehicle lane number may be carried out by the camera 111 or the locator 13. The weather and road conditions can be identified by combining the recognition results of the camera 111 with the weather information obtained by the information acquisition unit F1. In addition to the recognition results of the camera 111, the road structure may be identified using map data or the trajectory information of the forward vehicle.

The environment recognition unit F2 acquires information related to the structure of the road within a predetermined distance ahead of the subject vehicle based on at least one of the output signals from the surrounding monitoring sensors 11, the reception signals from external devices, and the map data. The road structure includes the position of gate points, the position of branch roads, the number of lane lines, the road width, and so on. The environment recognition unit F2 acquires the remaining distance to the gate points as detailed information regarding the gate points. The remaining distance to the gate points may be acquired based on map data or identified based on the data of guide signs detected by the camera 111. The environment recognition unit F2 may also identify the remaining distance to the gate points based on behavior data or sensing data received from the forward vehicle. The environment recognition unit F2 may acquire the number of gates and the payment method for each gate from the map data or the travel trajectory of the forward vehicle. The environment recognition unit F2 may regard gates that require stopping as manual payment gates, and gates that the forward vehicle passes through without stopping as automatic payment gates. In the environment recognition unit F2, a functional unit configured to acquire information related to gate points corresponds to a gate recognition unit F21.

The driving environment includes the position, type, and moving speed of objects present around a vehicle. The environment recognition unit F2 recognizes the positions and behaviors of surrounding vehicles based on various data acquired by the information acquisition unit F1. The software/hardware module responsible for the process of recognizing surrounding vehicles corresponds to a surrounding vehicle recognition unit F22. Additionally, the environment recognition unit F2 acquires external environment information related to the ODD, and the driver status data.

The mode control unit F3 controls the operation mode of the automated driving ECU 30 based on various types of information acquired by the information acquisition unit F1. The switching of operation modes is executed based on operation signals input from the input device 23. For example, if the driving environment satisfies the ODD and an automated driving start instruction signal is input from the input device 23, the mode control unit F3 switches the operation mode from the fully manual mode or the level 2 mode to the automated driving mode. Additionally, during the automated driving mode, if it is anticipated that the driving environment recognized by the environment recognition unit F2 will no longer satisfy the ODD, the mode control unit F3 may decide to transition to the fully manual mode and notify the planning unit F4 accordingly.

Furthermore, when an override operation by the driver is detected during the automated driving mode or level 2 mode, the mode control unit F3 switches to the fully manual mode. The override operation refers to the operation of the passenger on the operation element such as the steering wheel and/or the pedals. When the automated driving ECU 30 detects that the override operation has been performed by the driver, it promptly transfers driving authority to the driver and notifies that the mode has switched to manual driving through audio output or other means. The operation mode transitioned to at the end of the automated driving mode may be the level 2 mode.

The planning unit F4 is configured to plan the control content to be executed as level 2 or higher automated driving. The planning unit F4 can be activated when the operation mode is either level 3 or level 2 mode. While in level 3 or level 2 mode, the planning unit F4 generates a driving plan for automated driving based on the recognition results of the driving environment by the environment recognition unit F2. The driving plan can also be referred to as a control plan. The control plan includes a travel position, target speed, and steering angle for each time. That is, the driving plan may include schedule information for acceleration and deceleration to adjust the speed on the calculated route, as well as schedule information for the steering amount.

For example, the planning unit F4 performs route search processing as a medium-to-long-term driving plan and determines the planned driving route from the current subject-vehicle position to the destination. If a destination is not set, the planning unit F4 may select a route on which automated driving can continue as the planned driving route. The planned driving route includes data on the roads that will be traveled within a predetermined time (for example, 10 minutes).

The planning unit F4 generates a short-term control plan for driving in accordance with the medium-to-long-term driving plan, such as a driving plan for lane change, a driving plan for driving in the center of the lane, a driving plan for following a preceding vehicle, and a driving plan for obstacle avoidance. For example, the planning unit F4 may generate as the short-term control plan a driving route that follows the center of the recognized subject-vehicle lane, or generate a driving route that follows the behavior or driving trajectory of the recognized preceding vehicle. The control plan created by the planning unit F4 is input to the control execution unit F5.

In addition to control planning directly related to vehicle travel, the planning unit F4 also formulates a plan related to notification processing for passengers using notification devices such as the display 21. For example, the planning unit F4 plans the timing for executing pre-notifications/requests to the driver, such as behavior pre-notification, mode change notification, eyes-on request, hands-on request, and Take Over Request (TOR) pre-notification. The behavior pre-notification is the process of notifying the driver of anticipated vehicle behaviors such as lane changes, overtaking, and deceleration. The behavior pre-notification includes, for example, an anticipated behavior of the subject vehicle at the gate point, such as a gate number the vehicle plans to pass through. The mode change notification is the process of informing the driver that the operation mode is being changed or is scheduled to be changed.

The eyes-on request is the process of requesting the driver to monitor the surroundings as a precaution while in the level 3 mode. The hands-on request is the process of asking the driver to lightly grasp the steering wheel while in the level 3 mode or hands-off level 2 mode. The TOR pre-notification is the process of informing the driver that the likelihood of a Take-Over Request (TOR) is increasing. The TOR is the process of requesting the driver to take over the driving operation, in other words, to terminate automated driving.

Various notifications, including pre-notifications and requests, include displaying an icon image corresponding to their content on the display 21. The various notifications may involve some or all of the following: output of a notification sound, output of a voice message, flashing of an ambient light, and/or vibration of a vibrator depending on their importance and urgency.

The control execution unit F5 generates control commands based on the control plan generated by the planning unit F4, and sequentially outputs the control commands to the driving actuators 19, the display 21, and the like. Additionally, the control execution unit F5 also controls the lighting status of the direction indicators, headlights, hazard lights, etc., based on the plan of the planning unit F4 and the external environment, in accordance with the driving plan and external conditions.

The control execution unit F5 includes an ACC system F51 as a subsystem for executing preceding-vehicle following control. The ACC system F51 executes the preceding-vehicle following control based on the plan created by the planning unit F4. In other words, the ACC system F51 controls the vehicle speed to maintain a constant distance/time gap with the preceding vehicle within the range of the set speed when the preceding vehicle is recognized. Additionally, the ACC system F51 maintains the set vehicle speed when it does not recognize a preceding vehicle. The ACC system F51 can also be referred to as a preceding-vehicle following control unit.

The control execution unit F5 includes a notification control unit F52 as a subsystem for notifications/suggestions to the driver using notification devices such as the display 21 and the speaker 22. Various notifications/suggestions can be implemented by displaying images on the display 21 or outputting voice messages from the speaker 22.

For example, the notification control unit F52 notifies information at the timing set by the planning unit F4 using at least one of the display 21 and the speaker 22, the information indicating the behavior of the subject vehicle that is planned to reach a gate point within a predetermined time frame. More specifically, the notification control unit F52 outputs image data or audio data indicating the target gate to be passed, the trajectory before passing the gate, the trajectory after passing the gate, and the like, to the display 21 or the speaker 22.

The functional arrangement of the planning unit F4 and the control execution unit F5 can be modified as appropriate. These units may also be integrated. The software/hardware modules, including the planning unit F4 and the control execution unit F5, correspond to a vehicle control unit Fn.

### Response to Gate Point

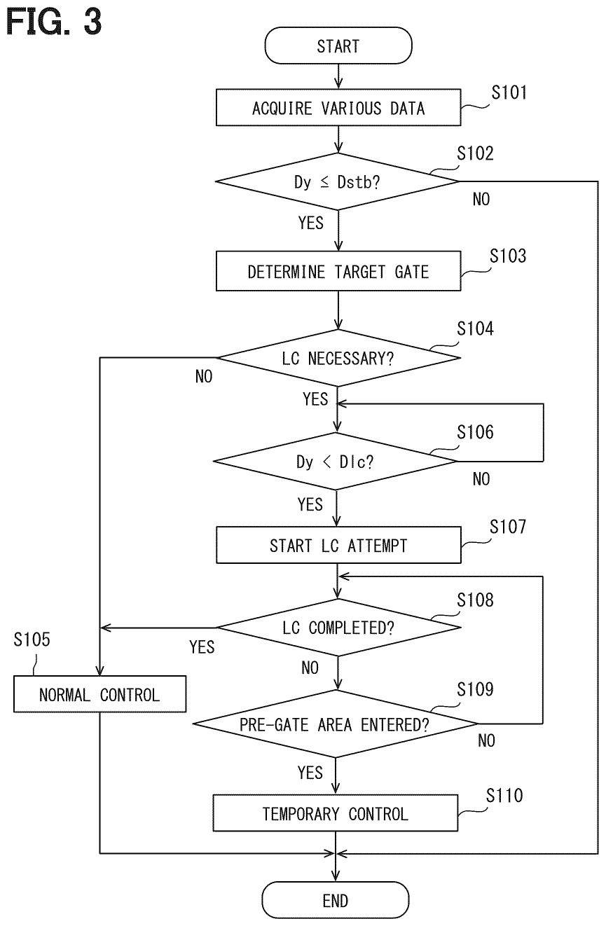

Here, the operation of the automated driving ECU 30 in a scene where the subject vehicle is traveling within a predetermined distance from a gate point while in the level 2 or level 3 mode will be explained using the flowchart shown in FIG. 3. The flowchart shown in FIG. 3 can be executed periodically while in the level 2/level 3 mode. The flowchart shown in FIG. 3 includes steps S101 to S110 as an example. In the following steps, the description of the processor 31 as the executing entity may be replaced with the information acquisition unit F1, environment recognition unit F2, mode control unit F3, planning unit F4, or control execution unit F5, as appropriate to the context.

Step S101 is a step in which the processor 31 acquires various types of information. The information acquisition unit F1 acquires, for example, the coordinates of the subject-vehicle position, the subject-vehicle lane number, the planned travel route, the remaining distance to the gate point, and information on surrounding vehicles. The information on surrounding vehicles includes the presence or absence of a preceding vehicle. Additionally, if a preceding vehicle is present, the information on surrounding vehicles also includes the distance to the preceding vehicle and the relative speed. The information on surrounding vehicles also includes the positions and speeds of other vehicles besides the preceding vehicle. The processing corresponding to step S101 is periodically executed even after step S103 and beyond.

Step S102 is a step that determines whether the remaining distance to the gate point has become less than or equal to a predetermined preparation start distance. The remaining distance to the gate point is the distance from the subject vehicle to the gate point in the extending direction of the road. The preparation start distance is, for example, 500 meters. The preparation start distance may also be 250 meters, 750 meters, or any other distance. As criteria for determining the remaining distance to the gate point, outputs from the surrounding monitoring sensors 11, data received from external devices, and map data, as mentioned above, can be employed.

The preparation start distance may also be dynamically determined based on the driving speed or the type of road being traveled. The preparation start distance may also be defined based on the concept of the amount of time it takes for the subject vehicle to reach the gate point. The preparation start distance may be set to a longer value as the number of lanes on the current road increases. The preparation start distance may be set to a longer value as the number of gates installed at the gate point ahead increases. In this disclosure, the road section where the remaining distance to the gate point is less than or equal to the predetermined preparation start distance is also referred to as a preparation section. In each figure, “Dy” indicates the remaining distance to the gate point. Additionally, “Dstb” shown in FIG. 3 represents the preparation start distance. The term “remaining distance to the gate point” can be appropriately replaced with “remaining distance to the target gate” as needed.

If the remaining distance to the gate point is less than or equal to the preparation start distance (S102: YES), the processor 31 executes the sequence from step S103 onwards. In other words, the processing from step S103 onwards is executed based on the remaining distance to the gate point becoming less than the predetermined preparation start threshold. On the other hand, if the remaining distance to the gate point exceeds the preparation start distance (S102: NO), this flow is terminated. When this flow is terminated, the flow may be re-executed after a predetermined idle time has elapsed from the termination point. The idle time may be set, for example, to 500 milliseconds, 1 second, 2 seconds, or the like.

Step S103 is a step of setting the target gate. The target gate is the gate through which the subject vehicle will pass among the multiple gates provided at the gate point. The setting of the target gate may be executed before the remaining distance to the gate point becomes equal to or less than the preparation start distance. The processor 31 sets a gate as the target gate among multiple gates. The selected gate corresponds to a post-gate road that the subject vehicle is scheduled to travel on after passing the gate point.

The gate corresponding to the post-gate road refers to a gate located directly before the post-gate road, in other words, a gate that allows entry onto the post-gate road by driving straight ahead after passing through the gate. The gate corresponding to the post-gate road can be understood as a gate leading to the post-gate road. From the opposite perspective, a road corresponding to a certain gate can be understood as a road located directly behind the gate, a road closest to the gate, or a road continuing from the gate along a road edge closest to the gate. The processor 31 may set a gate closest to an extension line of the current subject-vehicle lane as the target gate if there are multiple gates corresponding to the post-gate road.

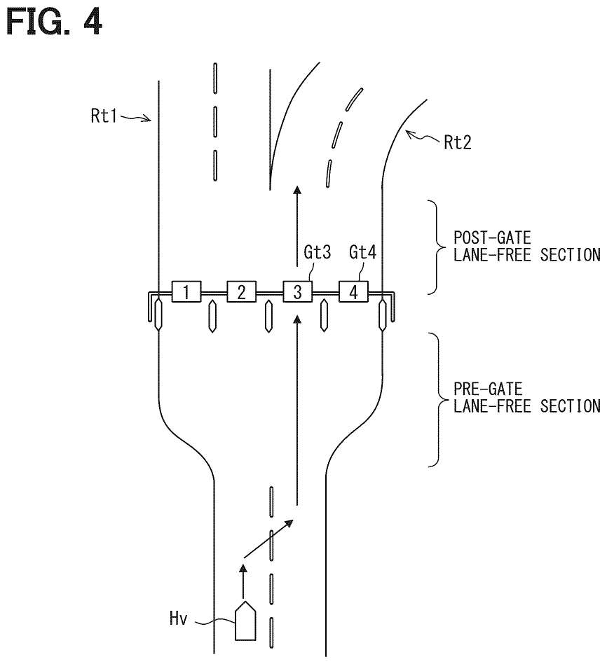

For example, as shown in FIG. 4, when the road behind the gate point branches into a first road Rt1 and a second road Rt2, and the second road Rt2 corresponds to the post-gate road for the subject vehicle, a third gate Gt3 is set as the target gate. Not only the third gate Gt3 but also a fourth gate Gt4 correspond to the second road Rt2 that is the post-gate road. The third gate Gt3 is closer to the current subject-vehicle lane than the fourth gate Gt4 is. Therefore, in the scene shown in FIG. 4, the processor 31 can set the third gate Gt3 as the target gate. “Hv” in FIG. 4 denotes the code indicating the subject vehicle.

Of course, if the third gate Gt3 meets a specific non-use condition, the processor 31 may set the fourth gate Gt4 as the target gate instead of the third gate Gt3. The non-use condition is met, for example, when the gate is blocked, when the payment method is manual, or when the third gate Gt3 is more crowded than the fourth gate Gt4. The target gate selection algorithm may be modified as appropriate. The processor 31 may select the target gate from among gates capable of automatic payment.

However, if the subject vehicle is unable to perform automatic payment processing, the processor 31 may select the target gate from among gates that allow manual payment. The inability to perform automatic payment processing refers to situations such as when the card for automatic payment is not inserted into a designated onboard device. If there is only one gate through which the subject vehicle can pass in terms of payment methods or other considerations, the processor 31 may set that gate as the target gate. If there is only one gate available due to closures or other restrictions, the processor 31 may also set that gate as the target gate.

Additionally, if no destination is set, the processor 31 may set a gate located in the extension line of the subject-vehicle lane as the target gate. Furthermore, if no destination is set, the processor 31 may set a road that can maintain the level 3 mode as the post-gate road and then set a gate corresponding to the post-gate road as the target gate.

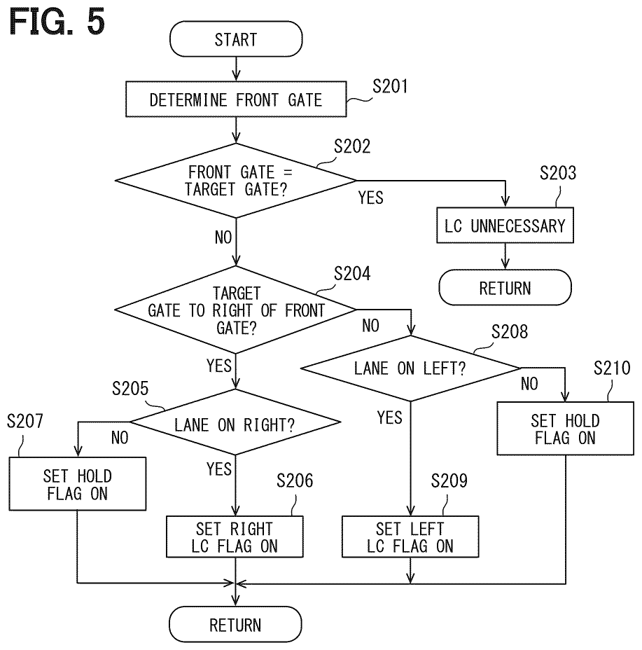

Once the target gate is set, the processor 31 determines whether a prior lane change is necessary for passing through the target gate based on the relationship between the position of the target gate and the current subject-vehicle position (S104). The prior lane change refers to a lane change made at a certain distance away from the gate, rather than immediately before the gate. For example, a lane change made at a distance of 50 meters or more away from the gate corresponds to the prior lane change for passing through the gate. The prior lane change is an example of a lateral movement towards the target gate. The determination of whether a prior lane change is necessary includes, for example, steps S201 to S210 as shown in FIG. 5.

Step S201 is a step of identifying a front gate which is a gate corresponding to the subject-vehicle lane. The front gate is a gate that exists on the extension line of the subject-vehicle lane. Step S202 is a step of determining whether the front gate matches the target gate. If the front gate matches the target gate (S202: YES), the processor 31 determines that a lane change is not necessary (S203).

On the other hand, if the front gate does not match the target gate (S202: NO), the processor 31 determines whether the target gate is located to the right of the front gate (S204). If the target gate is located to the right of the front gate (S204: YES), the processor 31 further determines whether there is another lane to the right of the subject-vehicle lane (S205). If there is another lane to the right of the subject-vehicle lane (S205: YES), the processor 31 sets the right lane change flag to ON (S206). The right lane change flag is a flag that indicates the need to change lanes to the right. “LC” as described in FIGS. 3 and 5, and the present document represents Lane Change. If there is no other lane to the right of the subject-vehicle lane (S205: NO), the processor 31 sets a right movement hold flag to ON (S207). The right movement hold flag is a flag that indicates the need to start moving to the right at the timing where the subject vehicle becomes able to move to the right due to road expansion or other reasons. When a flag is set to OFF, it means that the processor 31 does not need to execute the control associated with that flag.

Additionally, if the target gate is located to the left of the front gate (S204: NO), the processor 31 determines whether there is another lane to the left of the subject-vehicle lane (S208). If there is another lane to the left of the subject-vehicle lane (S208: YES), the processor 31 sets a left lane change flag to ON (S209). The left lane change flag is a flag that indicates the need to change lanes to the left. If there is no other lane to the left of the subject-vehicle lane (S208: NO), the processor 31 sets a left movement hold flag to ON (S210). The left movement hold flag is a flag that indicates the need to initiate a leftward movement at the timing where the subject vehicle becomes able to move leftward due to road expansion.

If the right or left lane change flag is set to ON in the above determination process, it corresponds to a case where the prior lane change is necessary (S104: YES). Additionally, if the target gate and the front gate match, or if a lane change is not possible due to the road structure, it corresponds to a case where a lane change is not necessary (S104: NO).

If a lane change is not necessary (S104: NO), the processor 31 performs normal control (S105). Normal control refers to the control where the subject vehicle travels along the road towards the target gate, in other words, the control that does not involve significant lateral movement equivalent to a lane change. Even during the execution of the normal control, if either the right movement hold flag or the left movement hold flag is set to ON, the vehicle will begin lateral movement towards the target gate, for example, at the timing of entering a pre-gate lane-free section or a road width expansion section.

In the present disclosure, a “lane-free section” refers to a section of the road where lane lines are not present on the road surface. The lane-free section also includes sections of the road where lane lines/paint are only applied to roads leading to some gates. Such lane-free sections may exist before and after the gates. The pre-gate lane-free section is a lane-free section that exists on the entrance side of the gates. The post-gate lane-free section is a lane-free section that exists on the exit side of the gates. The driving trajectory in the pre-gate lane-free section can be set to connect the end of the subject-vehicle lane with the target gate. The lane-free section is often a section where the road width has been temporarily expanded as a gate point. Therefore, the term “lane-free section” may be replaced with “road width expansion section.”

The processor 31, when it determines that a lane change is necessary (S104 YES), determines whether the remaining distance to the gate point has become less than a predetermined LC start distance (S106). The LC start distance is a parameter for initiating a lane change towards the target gate. The LC start distance can be set to a value smaller than the preparation start distance. The LC start distance may be the same as the aforementioned preparation start distance. In the drawings, “DIc” indicates the LC start distance. The LC start distance corresponds to a first distance. The preparation start distance and the LC start distance are set to values greater than the length of a pre-gate area described later, so as to encompass the pre-gate area.

The processor 31 begins to attempt a lane change in the direction of the target gate when the remaining distance to the gate point is less than the LC start distance (S107). Whether the lane change can actually be executed depends on the traffic conditions of the target lane. Step S108 is a step where it is determined whether the lane change has executed. If the lane change has executed (S108: YES), normal control is performed (S105).

On the other hand, if the lane change is incomplete, it is periodically determined whether the vehicle has entered the pre-gate area (S109). The pre-gate area refers to a road section within a predetermined distance ahead of the gate point. The area ahead of the gate is in the direction opposite to the current direction of travel. Additionally, the area behind the gate is in the current direction of travel (passing direction) set for the road or gate. The distance considered as the pre-gate area corresponds to a second distance. The second distance may be a fixed value such as 50 meters, 100 meters, or 150 meters. Alternatively, the second distance may be set to a larger value as the number of gates increases. The pre-gate area may be a pre-gate lane-free section. In that case, the length of the pre-gate lane-free section may correspond to the second distance.

If the lane change has not been completed even after entering the pre-gate area (S109: YES), the processor 31 executes temporary control. The temporary control corresponds to a control implemented when it is difficult to preemptively move to the lane suitable for passing through the target gate. In the temporary control, the amount of lateral movement just before the gate may be relatively larger compared to the normal control. Therefore, in the temporary control, the distance to surrounding vehicles may decrease, increasing the likelihood of reaching the system's limits compared to when the normal control is executed.

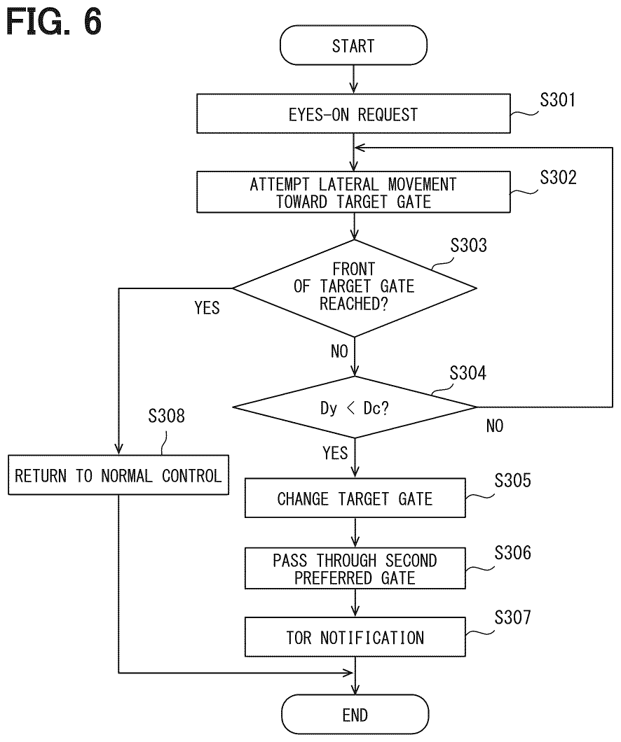

The temporary control may include steps S301 to S308, as shown in FIG. 6, for example. Step S301 is a step for executing an eyes-on request. Step S301 corresponds to a step where the system requests the driver to monitor the surrounding situation based on the fact that the subject vehicle has not yet moved into the lane corresponding to the target gate even after entering the pre-gate area. By including the eyes-on request in the temporary control, it becomes easier for the driver to take over the driving operation from the system. The display of the icon image requesting eyes-on may be continued until the vehicle reaches the front of the target gate.

Step S302 is a step for attempting lateral movement towards the target gate. The lateral movement here includes moving sideways while advancing, that is, advancing with the steering angle set to a predetermined value or more. The lateral movement can also be referred to as a lane change. The lateral movement includes not only lane changes, but also moving diagonally to the right or left in a lane-free section. Attempting lateral movement may include proceeding straight along the road while activating the turn signal lamp.

Attempting lateral movement can also continue in road sections where lane lines are present. Furthermore, attempting lateral movement can continue even after entering a pre-gate lane-free section. The speed during attempting lateral movement may be limited to a predetermined value or below. The target speed during attempting lateral movement may be set to a value that is a predetermined amount lower than the driver's set value. Here, the target speed refers to a target value when performing vehicle speed control. Additionally, when attempting lateral movement in a lane-free section, the processor 31 may activate the hazard lights. The lateral movement executed in step S302 also corresponds to lateral movement in the direction where the target gate is located.

Step S303 is a step for determining whether the subject vehicle has entered a virtual lane or an explicit lane leading to the target gate. The explicit lane leading to the target gate refers to a lane defined by lane lines that actually extend in the direction opposite to the direction of travel from the gate. The virtual lane refers to a lane estimated from the orientation of the gate, even though there are no lane lines. The virtual lane can be determined based on factors such as the trajectory of another vehicle, the direction in which the line of vehicles extends, and the direction connecting the gate and the road.

In short, the lane leading to the target gate is a road surface area located directly in front of the target gate. Therefore, step S303 can be understood as a step of determining whether the subject vehicle has reached the front of the target gate. If there is a line of vehicles in front of the target gate, reaching the end of this line of vehicles is also considered as having reached the front of the target gate. If the subject vehicle has reached the front of the target gate (S303: YES), the processor 31 may return to the normal control (S308). For example, returning to the normal control may include stopping the activation of the turn signals or hazard lights, and stopping the display on the external display device 18.

Step S304 is a step of determining whether the remaining distance to the gate point has become less than a predetermined gate change distance. The gate change distance is a distance at which the target gate is changed to a gate nearest from the current subject-vehicle position within the reachable range. For the purpose of distinguishing the target gate before and after the change, the initial target gate is referred to here as a first preferred gate. Additionally, the target gate after the change is referred to as a second preferred gate.

The gate change distance can be understood as one of the parameters that define the condition for giving up on reaching the first preferred gate. In the drawings, “Dc” represents the gate change distance. The gate change distance may be a fixed value, such as 25 meters, 50 meters, or 75 meters, for example. Additionally, the gate change distance may be set to a value corresponding to the length of the pre-gate lane-free section, such as 50% or 25% of the length of the pre-gate lane-free section. The gate change distance is set to be smaller than the second distance, which is the length of the pre-gate area. In the present disclosure, the gate change distance can also be referred to as a third distance.

If the remaining distance to the gate point becomes less than the gate change distance and the first preferred gate is not reached (S304: YES), the processor 31 changes the target gate to the second preferred gate (S305). As previously mentioned, the second preferred gate is the one that is closest to the first preferred gate among the gates that the subject vehicle can reach without difficulty within the remaining distance. At the moment when the remaining distance becomes less than the gate change distance, the gate that is in front of the subject vehicle can become the second preferred gate. According to the above configuration, lateral movement just before the gate is restricted, thereby reducing the risk of contact with surrounding vehicles.

Step S306 is a step where the vehicle passes through the second preferred gate in automated driving mode. The processor 31 performs a TOR notification based on the subject vehicle having passed through the second preferred gate (S307). When passing through the second preferred gate, the amount of lateral movement after passing through the gate is greater compared to when passing through the first preferred gate. Additionally, to enter the post-gate road, the subject vehicle may need to merge between other vehicles that have passed through the first preferred gate. In this way, when passing through the second preferred gate, there is a higher likelihood of reaching the system's limits. By notifying the driver in advance of the possibility of a TOR, a smooth transition of driving control can be achieved.

The above temporary control corresponds to a control that issues a TOR notification if the subject vehicle is unable to move to the lane leading to the first preferred gate, even when the remaining distance to the gate point is less than the gate change distance. The TOR notification may be issued when the remaining distance to the gate point is less than the second distance and the subject vehicle has not yet moved to the lane leading to the first preferred gate. The processor 31 may issue a TOR notification before passing through the second preferred gate. The execution conditions and timing of step S307 can be modified as appropriate.

Additionally, when the right movement hold flag is set to ON, the processor 31 may allow the subject vehicle to travel toward the target gate along a trajectory that is approximately parallel to the right edge of the road, in the event that a drivable space becomes available on the right side due to road expansion or similar circumstances. Additionally, when the left movement hold flag is set to ON, the processor 31 may allow the subject vehicle to travel toward the target gate along a trajectory that is approximately parallel to the left edge of the road, in the event that a drivable space becomes available on the left side due to road expansion or similar circumstances. Control Example of Operation Mode

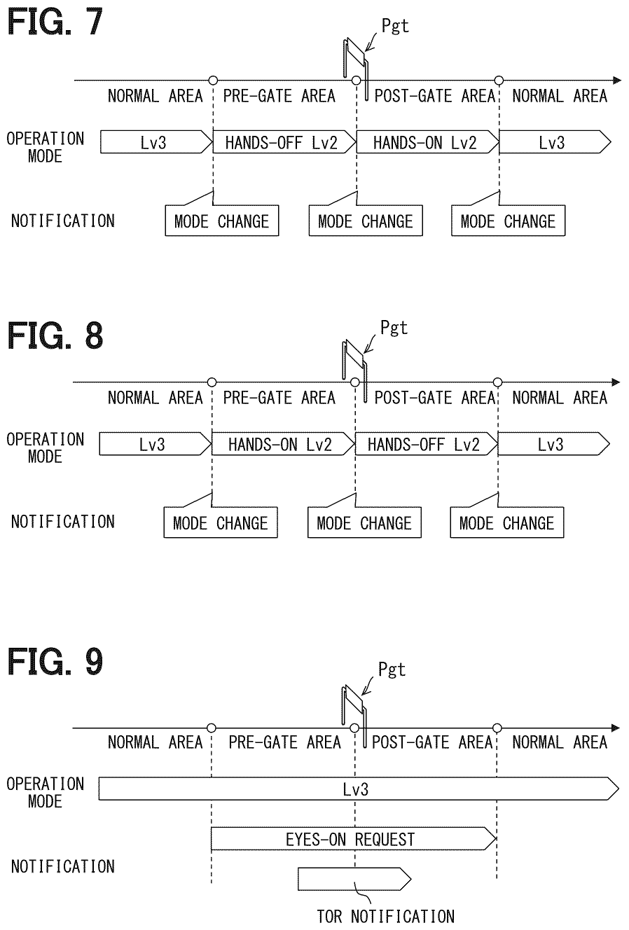

As shown in FIG. 7, the processor 31 may automatically change the operation mode based on the position of the subject vehicle relative to the gate point. In FIG. 7, an example pattern is illustrated where the processor 31 maintains the level 3 mode in the normal area, while transitioning to the level 2 mode near the gate. The processor 31 may transition to the hands-off level 2 mode in the pre-gate area, and to the hands-on level 2 mode in the post-gate area. Notifications regarding mode changes are carried out as needed.

It is more likely for vehicle paths to intersect after the gate than before the gate. Therefore, scenarios involving travel in the area immediately after passing through the gate are more likely to require advanced decision-making or communication with other vehicles. According to the configuration where the automation level is lowered after passing through the gate compared to before passing through the gate, it becomes possible to respond appropriately based on the driver's judgment in the aforementioned scenarios. As a result, smooth traffic flow can be achieved.

The area referred to as “post-gate area” here indicates the region within 50 meters or 100 meters from the gate in the direction of road extension. The processor 31 may consider the post-gate lane-free section as the post-gate area. If there is a branching point after the gate, the processor 31 may recognize an area up to the branching point as the post-gate area. The normal area refers to a region that is neither the pre-gate area nor the post-gate area.

Of course, the processor 31 may apply the hands-off level 2 mode to the post-gate area in the same manner as when the vehicle is traveling in the pre-gate area. The operation mode after passing through the gate may be changed depending on whether or not the first preferred gate has been reached. The processor 31 may maintain the hands-off level 2 mode after passing through the gate if the first preferred gate is successfully passed, while setting the operation mode to the hands-on level 2 mode if the first preferred gate is not successfully passed.

Additionally, since the lateral movement is greater in the pre-gate area, there is a viewpoint that it is better for the driver to be more involved in the driving operation when the vehicle is traveling in the pre-gate area compared to when it is traveling in the post-gate area. Therefore, as shown in FIG. 8, the processor 31 may be configured such that the hands-on level 2 mode is applied in the pre-gate area, and the hands-off level 2 mode is applied in the post-gate area. According to this control policy, an additional effect is achieved in that it becomes easier to pass through the gate according to the driver's preference.

Additionally, as shown in FIG. 9, the processor 31 may also maintain the level 3 mode while passing through the gate. In that case, the processor 31 may request the driver to keep their eyes on the road or hands on the wheel while maintaining the level 3 mode. Furthermore, it may also be permissible to implement a TOR notification depending on whether the first preferred gate could be passed and whether lateral movement is required after passing through the gate. According to this configuration, the driver can act as a partner/assistant in driving operations, potentially enhancing safety. Additionally, even when a driver takeover from the system is required, this configuration has the advantage of enabling the driver to smoothly assume control of the driving operations. Thus, the processor 31 may maintain the level 3 mode in the pre-gate area. The processor 31 may transition from the level 3 mode to the level 2 mode if lateral movement towards the post-gate road is required following the gate passage.

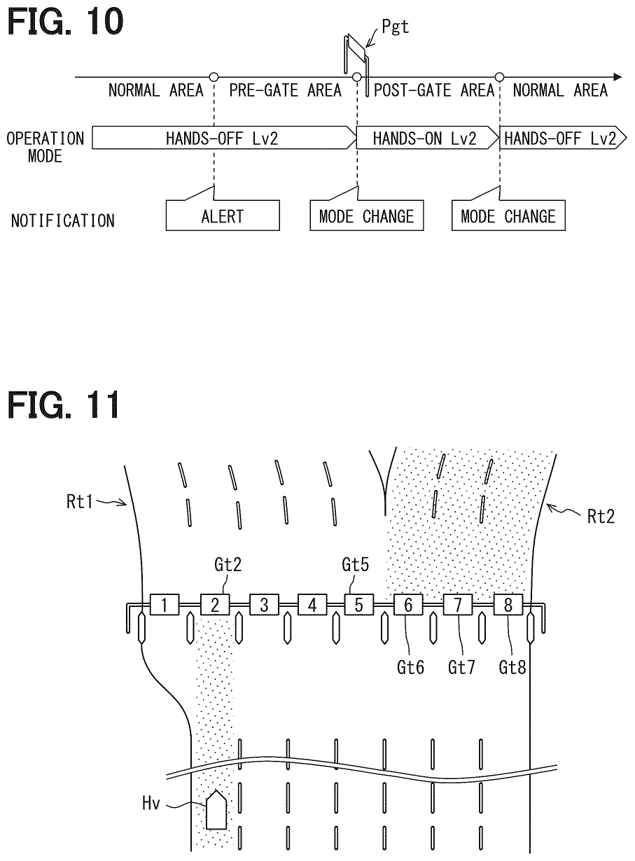

The above describes the case where the operating mode is the level 3 mode when the distance to the gate point is less than the preparation start distance. The above description is also applicable when the operating mode is the hands-off level 2 mode at the point where the distance to the gate point becomes less than the preparation start distance. For example, as shown in FIG. 10, while the hands-off level mode may be applied in the normal area, it may transition to the hands-on level 2 mode in the post-gate area. Whether to maintain the hands-off level 2 mode in the pre-gate area may be adjusted based on whether lateral movement is required in the pre-gate area. If lateral movement is not required in the post-gate area, the processor 31 may maintain the hands-off level 2 mode even in the post-gate area.

### Example of Target Gate Setting

The target gate as the first preferred gate does not necessarily have to be set to a gate located directly in front of the post-gate road. The processor 31 may select the first preferred gate from among the gates that do not correspond to the post-gate road, as long as a pre-gate lateral movement amount is equal to or greater than a post-gate lateral movement amount.

Here, the pre-gate lateral movement amount refers to an amount of movement in the lateral direction before passing through the gate. The pre-gate lateral movement amount is expressed by factors such as the number of lane changes before passing through the gate. The post-gate lateral movement amount refers to an amount of lateral movement required to enter the post-gate road after passing through the gate. In the present disclosure, the total movement amount required to pass through the gate is also referred to as a total lateral movement amount. The total lateral movement amount is the lateral distance from the front gate corresponding to the subject-vehicle lane at the point where the distance to the gate point becomes less than the preparation start distance, to the gate corresponding to the post-gate road. The post-gate lateral movement amount is the value obtained by subtracting the pre-gate lateral movement amount from the total lateral movement amount.

It is preferable that the processor 31 sets a gate that minimizes the lateral movement amount after the gate, from among the gates that do not correspond to the post-gate road, as the first preferred gate. Here, for the sake of simplicity in explanation, the lateral movement amount is expressed in terms of the number of lanes/gates, but it may actually be expressed in meters or other units.

For example, as shown in FIG. 11, when the vehicle moves from the first lane to the second road Rt2, the total lateral movement amount is four lanes. This is because the front gate is the second gate Gt2, and the nearest gate among the gates corresponding to the second road Rt2 is the sixth gate Gt6. In the drawings, to clearly indicate the front gate of the subject-vehicle lane and the gate corresponding to the second road Rt2, the virtual extension line from the subject-vehicle lane to the gate and the extension line from the second road Rt2 to the gate are shown with dot-pattern hatching. The seventh gate Gt7 and the eighth gate Gt8 also correspond to the gates corresponding to the second road Rt2. In FIG. 11, the gates located to the left of the fifth gate Gt5 correspond to the first road Rt1.

As shown in FIG. 11, when the total lateral movement amount is four, the processor 31 may allocate a pre-gate lateral movement amount of three and a post-gate lateral movement amount of one, and set the fifth gate Gt5 as the target gate. In a situation where the subject vehicle is in the pre-gate area, it is difficult to detect objects present in the post-gate area due to the gate. If the target gate is set such that the post-gate lateral movement amount is larger than the pre-gate lateral movement amount, the difficulty of control after passing through the gate will increase. This is because there may be obstacles that were not detected before passing through the gate. When comparing the pre-gate area and the post-gate area, the possibility of overlooking surrounding vehicles is smaller in the pre-gate area. By setting the target gate such that the pre-gate lateral movement amount is equal to or greater than the post-gate lateral movement amount, safety can be enhanced.

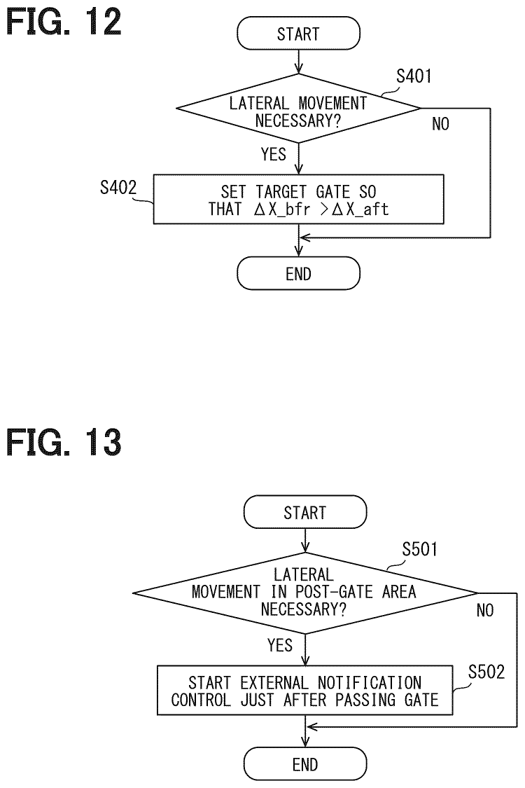

FIG. 12 is a flowchart illustrating the operation of processor 31 corresponding to the above technical idea. Step S401 is a step for determining whether lateral movement is necessary to enter the post-gate road. Step S401 may include a process of identifying the front gate corresponding to the current subject-vehicle lane and the gate corresponding to the post-gate road, and calculating the total lateral movement amount. If the front gate corresponds to the post-gate road, the total lateral movement amount may be zero. Step S401 may be executed when the remaining distance to the gate point becomes less than a predetermined value. The predetermined value here may be the preparation start distance or a value different from the preparation start distance.

Step S402 is a step of setting a target gate such that the pre-gate lateral movement amount is greater than or equal to the post-gate lateral movement amount, and creating a travel route. In that case, it is preferable to set the target gate such that the post-gate lateral movement amount is minimized as much as possible. In the drawings, “ΔX_bfr” represents the pre-gate lateral movement amount, and “ΔX_aft” represents the post-gate lateral movement amount.

### Example of Operation When Moving Laterally in the Post-Gate Area

As shown in FIG. 13, when lateral movement is necessary in the post-gate area (S501), the processor 31 may perform external notification control immediately after passing through the gate (S502). The external notification control is a control that notifies surrounding vehicles of the movement direction of the subject vehicle.

The external notification control may be the operation of the turn signal. The external notification control may alternatively be a control that alternates between the activation of the hazard lights and the operation of the turn signals. The external notification control may include sounding the horn. The external notification control may include displaying an image indicating the movement direction of the subject vehicle or an image requesting permission to merge to the rear vehicle in the moving direction on the external display device 18. The external notification control may include turning on or flashing the welcome lamp in the movement direction. The external notification control may alternatively be a control that sequentially activates multiple devices that output light or sound towards the outside of the vehicle. For example, the external notification control may include a sequence in which, after activating the turn signal, at least one of the following is performed: illuminating the hazard lights, sounding the horn, and displaying an image indicating the movement direction on the external display device 18.

The external notification control may involve controlling the turn signal to flash in a pattern different from the usual. The components of the flashing pattern may include the rhythm and speed of the blinking, the ratio of the illumination time to the extinguishing time, and the speed at which the light brightens. The external notification control may involve controlling the turn signal corresponding to the movement direction to flash at a higher speed than usual. The term “usual” refers to scenes other than immediately before or after the gate, such as when turning right or left, or when changing lanes in a straight section. In the present disclosure, the flashing speed of the turn signal during usual times is referred to as a first flashing speed, and the flashing speed during the external notification control is referred to as a second flashing speed. The first flashing speed may be 70 times per minute, for example. The second flashing speed is set to a value that is a predetermined amount higher than the first flashing speed. The second flashing speed may be set to the maximum flashing speed specified by laws or regulations. For example, the second flashing speed can be set to 120 times per minute or 100 times per minute. The processor 31 may continue the external notification control until the lateral movement is completed, or it may stop at a timing when a certain amount of time has passed since the start of execution.

The processor 31 may also perform the external notification control during the attempt of lateral movement while traveling in the pre-gate lane-free section. The intensity (degree of emphasis) of the external notification control before the gate may be reduced compared to that after the gate. The intensity of the notification increases as the flashing speed becomes faster or the light intensity becomes greater. Additionally, the intensity of the notification increases with the number of devices used for the external notification control. These controls correspond to performing at least one of the following when moving laterally in the lane-free section: activating the turn signal, illuminating the hazard lights, sounding the horn, and displaying an image indicating the movement direction on the external display device 18.

Even if the subject vehicle cannot pass through the first preferred gate, the processor 31 may execute a lane change after the subject vehicle has traveled a certain distance, provided that an immediate lane change is not necessary after passing through the gate. The situation where an immediate lane change is not necessary after passing through the gate includes, for example, cases where the distance from the gate to the branching point is 300 meters or more. In cases where an immediate lane change is not necessary after passing through the gate, the distance at which lane change is permitted, referred to as an LC release distance, may be 100 meters or 200 meters, for example.

The connection point between the branch road and the main road corresponds to a final change point, which is a point where the processor 31 needs to complete the lane change. If an immediate lane change is not necessary, this includes cases where the distance from the gate point to the final change point is greater than or equal to the LC release distance. The processor 31 may be configured to attempt a lane change after exiting the gate area, even if it fails to pass through the first preferred gate, provided that an immediate lane change is not necessary. It can be expected that the paths of surrounding vehicles are more stable in the normal area compared to the post-gate area. According to the above configuration, lane changes can be carried out more safely.

### Control of Preceding Vehicle Following Function

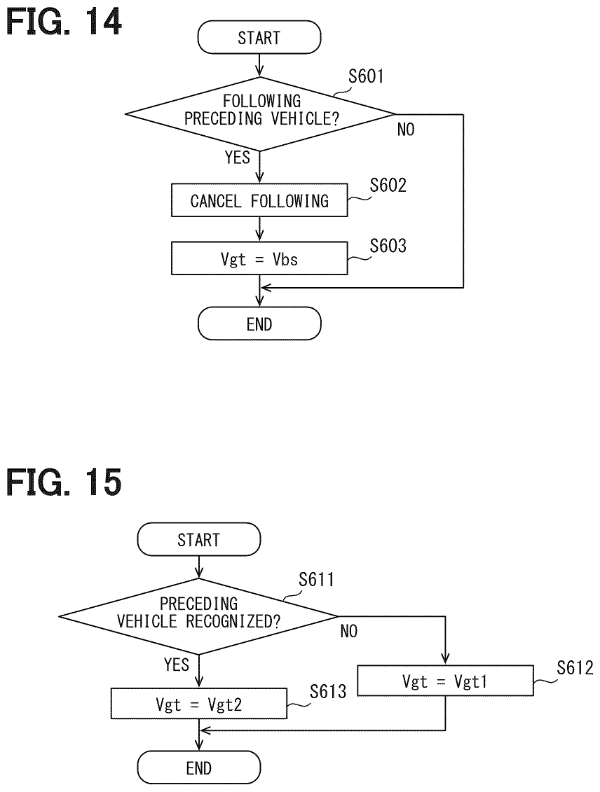

As shown in FIG. 14, when the remaining distance to the gate point falls below a predetermined value while following a preceding vehicle (S601: YES), the processor 31 may turn off the function of following the preceding vehicle (S602). This is because the gate that the preceding vehicle intends to pass through and the target gate of the subject vehicle may differ. Additionally, the processor 31 may cancel the following state based on the preceding vehicle starting to move laterally toward a gate different from the target gate of the subject vehicle.

If the preceding-vehicle following control is turned off in the gate area, the processor 31 may set the target speed to a basic speed for passing through the gate (S603). In the drawings, “Vbs” represents the basic speed. The basic speed may be a constant value, such as 20 km/h. The basic speed may also be a value obtained by multiplying the passing upper limit speed by a predetermined coefficient. The passing upper limit speed is the maximum speed at which the gate can be passed. The passing upper limit speed may be a constant value, or a unique value for each gate may be dynamically applied. The processor 31 may obtain the passing upper limit speed corresponding to the gate by referring to map data or by recognizing speed signs installed near the gate through image recognition. Additionally, the processor 31 may obtain the passing upper limit speed through wireless communication with the roadside unit.

Of course, the processor 31 may keep the preceding vehicle following function turned on even near the gate. In that case, the processor 31 may adjust a gate passing speed depending on whether it has recognized the preceding vehicle. The gate passing speed is a set vehicle speed when passing through the gate, in other words, the target speed. The processor 31 sets the gate passing speed to a predetermined higher value when the preceding vehicle has been recognized at a predetermined distance (for example, 15 meters) before the gate, compared to when the preceding vehicle has not been recognized. For convenience, the speed applied when the preceding vehicle has not been recognized is referred to as a first speed, and the speed applied when the preceding vehicle has been recognized is referred to as a second speed. Both the first speed and the second speed are set to values lower than the passing upper limit speed.

For example, if the passing upper limit speed is set to 20 km/h, the first speed may be set to 10 km/h and the second speed may be set to 20 km/h. When the passing upper limit speed is Vmx, the first speed is Vgt1, and the second speed is Vgt2, then Vgt1 can be determined as α·Vmx and Vgt2 can be determined as β·Vmx. β is a coefficient that is set to a value, for example, between 0.8 and 1.0. α is set to a value between 0.5 and less than β. α may be any value smaller than β.

When the preceding vehicle has been recognized and the subject vehicle is following the preceding vehicle, it is preferable in some scenarios to maintain the following state as much as possible. While following the preceding vehicle, adopting the highest possible value within the range of the passing upper limit speed as the gate passing speed can reduce the risk of losing the preceding vehicle. If, as a result of applying the second speed, the distance between the vehicle and the preceding vehicle becomes less than a predetermined value, the processor 31 may decelerate to maintain an appropriate inter-vehicle following distance/inter-vehicle time.

FIG. 15 is a flowchart showing an example of the operation of the processor 31 corresponding to the above technical idea. Step S610 is a step in which it is determined whether the preceding vehicle has been recognized at a predetermined distance before the gate. If the preceding vehicle has not been recognized before the gate (S611: NO), the processor 31 sets the gate passing speed to the first speed. If the preceding vehicle has been recognized before the gate, the processor 31 sets the gate passing speed to the second speed. In the drawings, “Vgt” represents the gate passing speed, “Vgt1” represents the first speed, and “Vgt2” represents the second speed.

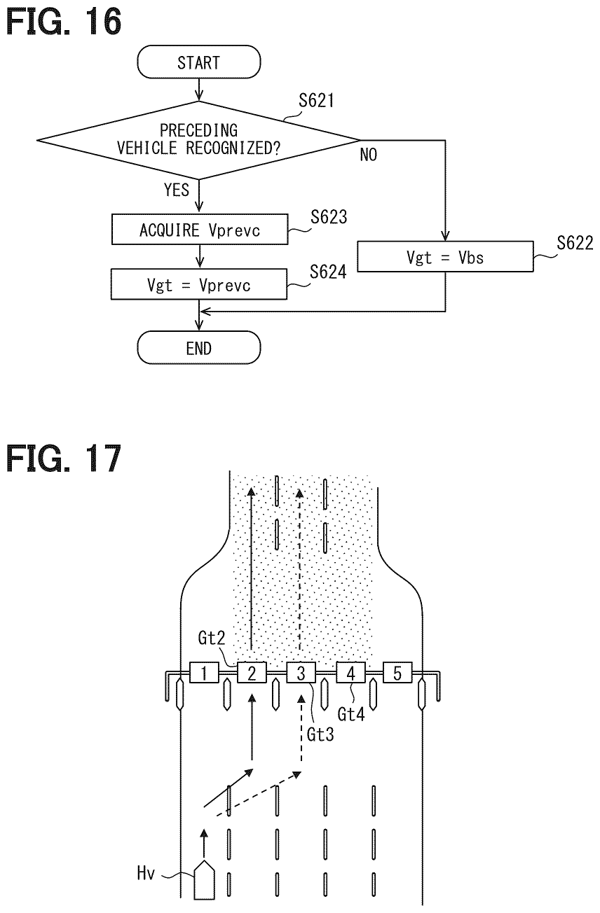

Additionally, if the processor 31 has recognized the preceding vehicle at a predetermined distance before the gate, it may adopt the speed at which the preceding vehicle passes through the gate as the gate passing speed for the subject vehicle. Specifically, as shown in FIG. 16, if the processor 31 has recognized the preceding vehicle before the gate (S621: YES), the processor 31 acquires the speed at which the preceding vehicle passes through the gate (S623). In the drawings, “Vprevc” represents the speed at which the preceding vehicle passes through the gate. Then, the processor 31 sets the gate passing speed of the subject vehicle to the speed at which the preceding vehicle passes through the gate (S624). If the preceding vehicle has not been recognized before the gate (S621: NO), the gate passing speed is set to the default speed (S622). In the drawings, “Vbs” represents the basic speed.

The preceding vehicle that has passed through the gate may accelerate. On the other hand, it is not preferable for the subject vehicle to accelerate before passing through the gate. According to the above configuration, the subject vehicle does not follow the real-time speed of the preceding vehicle. According to the above configuration, it is possible to suppress unnecessary acceleration before passing through the gate.

### Summary of Embodiment

Based on the remaining distance to the gate point being less than a predetermined value, the processor 31 initiates the movement to the lane that leads to the target gate. According to such a configuration, it is possible to gradually approach the target gate with sufficient time margin. In other words, it is possible to reduce the amount of lateral movement just before the gate. Not only the post-gate area but also the area immediately before the gate is a section where the trajectories of vehicles are relatively likely to intersect. According to the above configuration, the possibility of abnormal proximity to other vehicles near the gate can be further reduced. Here, abnormal proximity refers to a state in which the vehicles are so close that the driver perceives a risk of contact, such as when the distance between vehicles is less than 0.5 meters.

The processor 31 notifies the driver that there is a possibility of terminating the automated driving control if the movement to the lane leading to the target gate has not been completed even when the remaining distance to the target gate falls below a predetermined value. According to this configuration, even if a situation arises where it is unavoidable to perform a TOR, a smooth transition of driving control can be achieved.

Additionally, the processor 31 can modify the target speed for passing through the target gate based on whether a preceding vehicle has been recognized. For example, if a preceding vehicle has not been recognized, a relatively slower first speed is applied as the target speed, whereas if a preceding vehicle has been recognized, a relatively faster second speed is applied as the target speed. According to this configuration, the risk of losing the preceding vehicle can be reduced. Additionally, when the preceding vehicle has not been recognized, the vehicle passes through the gate at a lower speed compared to when the preceding vehicle has been recognized, thereby enhancing safety.

Of course, when the preceding vehicle has been recognized, the processor 31 may adopt the speed at which the preceding vehicle passes through the gate as the target speed. This control corresponds to replicating the behavior of the preceding vehicle when passing through the gate. By having the subject vehicle exhibit behavior similar to that of the preceding vehicle, the risk of disrupting the flow of traffic can be reduced.

When the vehicle performs lateral movement in a lane-free section, the processor 31 executes at least one of the following external notification controls: activating the turn signals, turning on the hazard lights, sounding the horn, and displaying an image indicating the movement direction on the external display device 18. According to this configuration, it becomes easier for drivers of surrounding vehicles to recognize the behavior of the subject vehicle. Additionally, as a result, the likelihood of abnormal proximity can be reduced.

Furthermore, if it is necessary to perform lateral movement after passing through a gate, the processor 31 initiates the activation of the turn signals as the external notification control either at the timing of passing through the gate or within a predetermined distance after passing the target gate. According to this configuration, there is the advantage that drivers of surrounding vehicles can recognize the behavior of the subject vehicle soon after it passes through the gate.

The processor 31 sets the target gate such that the lateral movement amount after passing through the gate is smaller than the lateral movement amount before passing through the gate. In other words, the processor 31 generates a travel trajectory near the gate such that the lateral movement amount after passing through the gate is smaller than the lateral movement amount before passing through the gate. According to this configuration, as mentioned above, safety can be enhanced.

The processor 31, if the first preferred gate cannot be passed, attempts to change lanes after exiting the gate area if there is no immediate need to change lanes. According to this configuration, safety is further enhanced.

In a configuration where the target gate is set based on map data, it is possible that the target gate may be recognized as impassable due to a broken-down vehicle or other obstruction only after approaching the target gate. This is because such dynamic events take time to be reflected in the map data. The processor 31 may change the target gate or issue a driver takeover request if it detects another vehicle reversing or with its hazard lights on at the target gate using the camera 111 or other sensors. Similarly, if the processor 31 detects that the target gate is blocked, it may change the target gate or issue a driver takeover request. By performing the operation of changing the target gate in the above scenario, the continuity of automated driving can be enhanced. Additionally, by implementing a configuration that allows for driver takeover in the above scenario, the driver can be entrusted with responding to unforeseen situations.

Determination of Entry into Gate Area Using a Map

The map data may include node data and link data. The node data refers to data regarding multiple feature points (nodes) on roads. For example, nodes are set at locations where roads intersect, merge, or diverge, at points where the number of lanes increases or decreases, and at gate points. The link data refers to data regarding road segments (links) that connect the nodes. The link data includes information such as a link ID that is a unique number identifying the link, a link length indicating the length of the link, a link direction, link shape information, node coordinates or node numbers of the link's start and end points, and road attributes. The node data includes information such as a node ID that is a unique number for each node, position coordinates of the nodes, the names, the types, and the link IDs of the links connected to the nodes.

Such node data may also include node map data indicating the road layout within the area related to the nodes. The node map data corresponds to partial map data within a certain range based on the nodes.

If the map data stored in the map storage unit 14 includes the node map data as described above, the processor 31 may execute various processes from step S103 onwards based on the subject vehicle entering an area indicated by the node map data associated with the gate point. In other words, the case where the remaining distance to the gate point falls below a predetermined value includes a case where the subject vehicle enters the area indicated by the node map data associated with the gate point. The gate area may be a range indicated by the node map data associated with the gate point.

### Application Example to a Scene Where Lanes Merge After a Gate

The above explanation describes the operation of processor 31 in the case where a branch road exists behind the gate point, but it is not limited to this scenario. The present disclosure is also applicable to cases where, as shown in FIG. 17, there is only one road behind the gate point, in other words, when no branch road exists. When there is only one road behind the gate, as shown in FIG. 17, that road corresponds to the post-gate road.

Additionally, as shown in FIG. 17, the road width and the number of lanes may decrease within a predetermined distance behind the toll gate. If the width of the post-gate road is smaller than the road width at the gate point, the trajectory of a vehicle passing through the gate on the far right or left can become diagonal relative to the road extension direction. In other words, even if there are no branch roads behind the gate, if the post-gate area has a structure where the road width decreases, the trajectories of the vehicles are more likely to intersect. Therefore, contact between vehicles is more likely to occur.

To address this issue, as described above, the processor 31 in this disclosure is configured to set the gate that is located directly in front of the post-gate road among the multiple gates, thereby being able to suppress the post-gate lateral movement amount even in road structures such as the one shown in FIG. 17. As a result, there will no longer be a need to merge into the line of vehicles entering the post-gate road in the post-gate area. In FIG. 17, the second gate Gt2, the third gate Gt3, and the fourth gate Gt4 correspond to the gates associated with the post-gate road. If the subject-vehicle lane is the first lane, the second gate Gt2 can be the target gate. However, if the second gate Gt2 is closed or does not support the payment method of the subject vehicle, another gate such as the third gate Gt3 may be set as the target gate.

The decision process in steps S104 to S110, which includes steps S201 to S210, may be repeatedly executed until the target gate becomes the front gate for the subject vehicle. Lane changes toward the target gate may be performed multiple times. Additionally, virtual lanes can exist even in the lane-free section. A virtual lane can be understood as a trajectory that many vehicles follow, in other words, a trajectory that is considered valid or reasonable. Due to such circumstances, lateral movement in the lane-free section may also be considered as lane changes.

A mode is described, in which the aforementioned processor 31 regards the road section where the remaining distance to the gate point becomes less than or equal to the preparation start distance as the preparation distance. However, the processor 31 may also be configured to regard the pre-gate area as the preparation section. Additionally, the processor 31 may be configured to regard the lane-free section as the preparation section.

### Vehicles Applicable to the Present Disclosure

The above embodiment is applicable to a variety of vehicles that travel on roads. The present disclosure can be applied to various vehicles capable of traveling on roads, including not only four-wheeled vehicles but also two-wheeled vehicles, three-wheeled vehicles, and the like. Motorized bicycles can also be included in the two-wheeled vehicles. The subject vehicle may be an electric vehicle or an engine-powered vehicle. Electric vehicles can include not only electric cars but also plug-in hybrid vehicles, hybrid vehicles, and fuel cell vehicles. The vehicle to which the system/apparatus/method of the present disclosure is applied may be an owner car owned by an individual or a service car. The service car refers to a vehicle provided for services such as car-sharing services or vehicle rental services. The service car includes a taxi, a route bus, and a shared bus.

A vehicle control device may be configured to execute automated driving control to autonomously drive a vehicle. The vehicle control device may include a control device. The control device is configured to carry out acquiring information about a gate point based on an output signal from a surrounding monitoring sensor, wireless signal received from an external device, or map data. The gate point is a location on a toll road where multiple gates are provided. The control device is further configured to carry out setting a target speed, which is a target travel speed, to a predetermined value for passing through a gate based on the vehicle entering a gate area which is an area determined as a reference.

The various flowcharts presented in the present disclosure are merely examples, and the number of steps constituting the flowcharts or the execution order of the processes can be modified as appropriate. The various process flows presented in the present disclosure may be implemented in parallel with other processes, in combination with other processes, or as partial replacements for other processes. Expressions in the present disclosure referring to a remaining distance to a gate point being less than a predetermined value may be replaced with expressions indicating that the subject vehicle has entered the gate area. For example, step S102 may be a step that determines whether the subject vehicle has entered the gate area.

Additionally, the apparatus, system, and methods described in the present disclosure may be implemented by a dedicated computer comprising a processor programmed to execute one or more functions embodied in a computer program. The apparatus and methods described in the present disclosure may also be implemented using dedicated hardware logic circuits. The apparatus and methods described in the present disclosure may be implemented by one or more dedicated computers comprising a combination of a processor executing a computer program and one or more hardware logic circuits. For example, some or all of the functions provided by the processor 31 may be implemented as hardware. Implementation of a certain function as hardware includes using one or more integrated circuits (ICs). As the processor (arithmetic core), a CPU, an MPU, a GPU, a DFP (Data Flow Processor), or the like can be adopted. Some or all of the functions provided by the processor 31 may be implemented using a System-on-Chip (SoC), Integrated Circuit (IC), or Field-Programmable Gate Array (FPGA). The computer program may be stored as instructions executed by a computer on a computer-readable non-transitory tangible storage medium. As a storage medium for storing the computer program, a hard disk drive (HDD), a solid state drive (SSD), a flash memory, or the like can be adopted. A program for enabling the computer to function as the processor 31, as well as non-transitory tangible recording media such as semiconductor memory that store this program, are also within the scope of this disclosure.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A vehicle control device configured to execute automated driving control to autonomously drive a vehicle, the vehicle control device comprising a controller configured to carry out:
acquiring information about a gate point based on an output signal from a surrounding monitoring sensor, a wireless signal received from an external device, or map data, the gate point being a location on a toll road where multiple gates are provided;
acquiring data regarding a post-gate road that the vehicle is scheduled to travel on after passing the gate point;
setting a target gate as a gate closest to the post-gate road among the multiple gates provided at the gate point; and
executing lateral movement of the vehicle in a direction toward the target gate based on the vehicle entering a preparation section that exists before the target gate.

2. The vehicle control device according to claim 1, wherein
the controller is further configured to carry out changing the target gate to another gate and notifying a driver that there is a possibility of termination of the automated driving control when a lane change toward the target gate has not been completed and a remaining distance to the target gate becomes less than a predetermined value.

3. The vehicle control device according to claim 1, further comprising:
a preceding-vehicle following control unit as a subsystem for the automated driving control, the preceding-vehicle following control unit being configured to carry out preceding-vehicle following control to drive the vehicle to follow a preceding vehicle while maintaining a predetermined inter-vehicle distance, wherein
the controller is further configured to carry out changing a target speed of the vehicle for passing through the target gate according to whether the preceding vehicle has been recognized.

4. The vehicle control device according to claim 3, wherein
the controller is further configured to carry out:
setting the target speed as a predetermined first speed when the preceding vehicle has been recognized, the first speed being determined depending on a maximum allowable speed for passing through the gate; and
setting the target speed as a second speed that is lower than the first speed when the preceding vehicle has not been recognized.

5. The vehicle control device according to claim 3, wherein
the controller is further configured to carry out:
setting the target speed as a passing speed of the preceding vehicle passing through the gate when the preceding vehicle has been recognized; and
setting the target speed as a predetermined value smaller than a maximum allowable speed for passing through the gate when the preceding vehicle has not been recognized.

6. The vehicle control device according to claim 1, wherein
the controller is further configured to carry out:
determining whether the vehicle is traveling in a lane-free section where lane lines are not present, based on the output signal from the surrounding monitoring sensor, the wireless signal received from the external device, or the map data; and
executing predetermined external notification control when the vehicle moves in a lateral direction in the lane-free section, and
the external notification control includes at least one of:
activating a turn signal;
lighting a hazard lamp;
sounding a horn;
lighting a welcome lamp; and
displaying an image indicating a movement direction of the vehicle on an external display device.

7. The vehicle control device according to claim 1, wherein
the controller is further configured to carry out initiating activation of a turn signal either from when passing the target gate or within a predetermined distance after passing the gate, when the vehicle moves in a lateral direction after passing through the gate.

8. The vehicle control device according to claim 1, wherein
the controller is further configured to carry out setting the target gate such that an amount of lateral movement after passing through the target gate is smaller than an amount of lateral movement before passing through the target gate.

9. The vehicle control device according to claim 1, wherein
the controller is further configured to carry out changing the target gate or executing a driving takeover request when it is detected that another vehicle is reversing in the target gate, that another vehicle has a hazard light turned on, or that the target gate is blocked.

10. The vehicle control device according to claim 1, wherein
the controller is further configured to carry out:
switching between a first mode, in which the automated driving control is performed without an obligation of surrounding monitoring, and a second mode, in which the automated driving control is performed with the obligation of surrounding monitoring; and
maintaining the second mode within a predetermined distance from the gate point.

11. The vehicle control device according to claim 1, wherein
the controller is further configured to carry out:
changing the target gate to another gate when a remaining distance to the gate point becomes less than a predetermined value and movement to a lane leading to the target gate has not been completed;
determining whether a lane change to be executed after passing through the newly set target gate is necessary;
specifying a final change point which is a location where the lane change needs to be completed when determining that the lane change is necessary; and
executing the lane change after traveling a predetermined distance from the target gate when the final change point is the predetermined distance or more away from the target gate.

12. The vehicle control device according to claim 1, wherein
the controller is further configured to carry out setting the target gate as a gate that lies on an extension line of a lane in which the vehicle is currently traveling when a destination is not set.

13. The vehicle control device according to claim 1, further comprising
a preceding-vehicle following control unit as a subsystem for the automated driving control, the preceding-vehicle following control unit being configured to carry out preceding-vehicle following control to drive the vehicle to follow a preceding vehicle while maintaining a predetermined inter-vehicle distance, wherein
the controller is further configured to carry out stopping the preceding-vehicle following control based on a remaining distance to the target gate being less than a predetermined value.

14. The vehicle control device according to claim 1, wherein
the controller is further configured to carry out setting a target speed, which is a target travel speed, to a predetermined value for passing through a gate based on the vehicle entering a gate area which is an area determined with reference to the gate point.

15. A vehicle control method for executing automated driving control to autonomously drive a vehicle, the method comprising:
acquiring information about a gate point based on an output signal from a surrounding monitoring sensor, a wireless signal received from an external device, or map data, the gate point being a location on a toll road where multiple gates are provided;
acquiring data regarding a post-gate road that the vehicle is scheduled to travel on after passing the gate point;
setting a target gate as a gate closest to the post-gate road among the multiple gates provided at the gate point; and
executing lateral movement of the vehicle in a direction toward the target gate based on the vehicle entering a preparation section that exists before the target gate.

16. A non-transitory computer readable storage medium storing a program comprising instructions executed by at least one processor included in a vehicle control device configured to execute automated driving control to autonomously drive a vehicle, the instructions configured to, when executed by the at least one processor, cause the at least one processor to carry out:
acquiring information about a gate point based on an output signal from a surrounding monitoring sensor, a wireless signal received from an external device, or map data, the gate point being a location on a toll road where multiple gates are provided;
acquiring data regarding a post-gate road that the vehicle is scheduled to travel on after passing the gate point;
setting a target gate as a gate closest to the post-gate road among the multiple gates provided at the gate point; and
executing lateral movement of the vehicle in a direction toward the target gate based on the vehicle entering a preparation section that exists before the target gate.
